(19) United States
(12) Patent Application Publication
(10) Pub. No.: US 2025/0056219 A1
(43) Pub. Date: Feb. 13, 2025

(54) NEGOTIATION OF SECURITY MECHANISMS THAT IMPLEMENT COMBINED INTEGRITY AND ENCRYPTION ALGORITHMS

(71) Applicant: Nokia Technologies Oy, Espoo (FI)

(72) Inventors: Suresh P NAIR, Estero, FL (US); Ranganathan MAVUREDDI DHANASEKARAN, Munich (DE)

(21) Appl. No.: 18/775,692

(22) Filed: Jul. 17, 2024

(30) Foreign Application Priority Data
Aug. 10, 2023 (GB) 2312229.4

(51) Int. Cl. H04W 12/041; H04W 12/03; H04W 12/0431

(52) U.S. Cl. CPC H04W 12/041; H04W 12/03; H04W 12/0431

(57) ABSTRACT

Negotiating security mechanisms (300) between user equipment and a network. In an embodiment, an access and mobility management function (212) is operatively coupled to user equipment (106). The access and mobility management function comprises a means (1504) for identifying security capabilities of the user equipment in supporting one or more non-access stratum combined integrity and encryption algorithms (1050), a means (1504) for selecting a non-access stratum combined integrity and encryption algorithm from the one or more non-access stratum combined integrity and encryption algorithms to protect non-access stratum signaling, and a means (1502) for sending a non-access stratum security mode command message (2312) to the user equipment indicating the non-access stratum combined integrity and encryption algorithm.

### TECHNICAL FIELD

This disclosure is related to the field of communication systems and, in particular, to next generation networks.

### BACKGROUND

Next generation networks, such as Fifth Generation (5G), denote the next major phase of mobile telecommunications standards beyond Fourth Generation (4G) standards. In comparison to 4G networks, next generation networks may be enhanced in terms of radio access and network architecture. Next generation networks intend to utilize new regions of the radio spectrum for Radio Access Networks (RANs), such as millimeter wave bands.

With mobile networks widely used across the country and the world, communications may be intercepted or suffer from other kinds of attacks. To ensure security and privacy, the 3rd Generation Partnership Project (3GPP) has set forth security mechanisms for 5G mobile networks, and the security procedures performed within the 5G mobile networks. Due to the importance of security in 5G systems and beyond, it is desirable to continue to develop more robust security mechanisms.

### SUMMARY

Described herein are enhanced security mechanisms for 5G systems. Communications (i.e., signaling or user plane data) within a 5G system may be protected via integrity protection and/or encryption. Previously, separate integrity algorithms and encryptions algorithms were implemented. In embodiments described herein, combined integrity and encryption algorithms are implemented, which are configured to apply integrity protection and/or encryption using a single key. One technical benefit is fewer keys are derived for the security mechanisms. Another technical benefit is separate integrity protection algorithms and encryptions algorithms do not have to be provisioned and managed. The encryption procedure and the computation of an integrity code (i.e., message authentication code) may also be accomplished as a single procedure.

In an embodiment (also referred to as an aspect), an access and mobility management function (AMF) is operatively coupled to user equipment (UE) to negotiate security mechanisms. The access and mobility management function comprises a means for identifying security capabilities of the user equipment in supporting one or more non-access stratum combined integrity and encryption algorithms, a means for selecting a non-access stratum combined integrity and encryption algorithm from the one or more non-access stratum combined integrity and encryption algorithms to protect non-access stratum signaling, and a means for sending a non-access stratum security mode command message to the user equipment indicating the non-access stratum combined integrity and encryption algorithm.

In an embodiment, the non-access stratum combined integrity and encryption algorithm supports multiple operating modes. The means for selecting comprises a means for selecting an operating mode from the multiple operating modes for the non-access stratum combined integrity and encryption algorithm, and the means for sending comprises a means for sending the non-access stratum security mode command message to the user equipment indicating the non-access stratum combined integrity and encryption algorithm and the operating mode for the non-access stratum combined integrity and encryption algorithm.

In an embodiment, the multiple operating modes at least comprise an integrity and encryption mode, an integrity mode, an encryption mode; and NULL encryption and NULL integrity mode.

In an embodiment, the integrity mode comprises at least one of an ignore encryption and integrity mode, where the non-access stratum combined integrity and encryption algorithm is configured to apply integrity protection and encryption to the non-access stratum signaling using a non-access stratum combined integrity and encryption key, but ciphered data is ignored, and NULL encryption and integrity mode, where the non-access stratum combined integrity and encryption algorithm is configured to apply integrity protection and NULL encryption to the non-access stratum signaling using the non-access stratum combined integrity and encryption key.

In an embodiment, the non-access stratum security mode command message is extended to indicate the non-access stratum combined integrity and encryption algorithm and the operating mode selected from the multiple operating modes for the non-access stratum combined integrity and encryption algorithm.

In an embodiment, the non-access stratum combined integrity and encryption algorithm uses at least one of additional authenticated data and extra entropy data as input parameters to generate a non-access stratum message authentication code.

In an embodiment, the additional authentication data comprises one of a 5G temporary mobile subscriber identity, TMSI, of the user equipment, a truncated 5G-S-TMSI, or network slice selection assistance information.

In an embodiment, the extra entropy data comprises a random number generated by the access and mobility management function.

In an embodiment, the access and mobility management function further comprises a means for identifying the additional authenticated data, and a means for identifying the extra entropy data. Wherein the means for sending comprises a means for sending the non-access stratum security mode command message to the user equipment containing at least one of the additional authenticated data and the extra entropy data.

In an embodiment, the non-access stratum security mode command message is extended to contain at least one of the additional authenticated data and the extra entropy data.

In an embodiment, wherein the means for identifying comprises a means for receiving a non-access stratum message from the user equipment that indicates the one or more non-access stratum combined integrity and encryption algorithms supported by the user equipment, and a user equipment security capability information element of the non-access stratum message is extended to indicate the one or more non-access stratum combined integrity and encryption algorithms supported by the user equipment.

In an embodiment, a radio access network node (e.g., gNB) operatively coupled to user equipment. The radio access network node comprises a means for identifying security capabilities of the user equipment in supporting one or more access stratum combined integrity and encryption algorithms, a means for selecting an access stratum combined integrity and encryption algorithm from the one or more access stratum combined integrity and encryption algorithms to protect radio resource control signaling, and a means for sending an access stratum security mode command message to the user equipment indicating the access stratum combined integrity and encryption algorithm.

In an embodiment, the access stratum combined integrity and encryption algorithm supports multiple operating modes, the means for selecting comprises a means for selecting an operating mode from the multiple operating modes for the access stratum combined integrity and encryption algorithm selected to protect the radio resource control signaling, and the means for sending comprises a means for sending the access stratum security mode command message to the user equipment indicating the access stratum combined integrity and encryption algorithm and the operating mode for the access stratum combined integrity and encryption algorithm.

In an embodiment, a security algorithm configuration information element of the access stratum security mode command message is extended to indicate the access stratum combined integrity and encryption algorithm and the operating mode selected from the multiple operating modes for the access stratum combined integrity and encryption algorithm.

In an embodiment, the access stratum combined integrity and encryption algorithm uses at least one of additional authenticated data and extra entropy data as input parameters to generate a message authentication code.

In an embodiment, the additional authentication data comprises at least one of a radio network temporary identifier, and a physical cell identifier.

In an embodiment, the extra entropy data comprises a random number generated by the radio access network node.

In an embodiment, the radio access network node further comprises a means for identifying the additional authenticated data, and a means for identifying the extra entropy data. The means for sending comprises a means for sending the access stratum security mode command message to the user equipment containing at least one of the additional authenticated data and the extra entropy data.

In an embodiment, a security algorithm configuration information element of the access stratum security mode command message is extended to contain at least one of the additional authenticated data and the extra entropy data.

In an embodiment, the radio access network node further comprises a means for selecting an access stratum combined integrity and encryption algorithm from the one or more access stratum combined integrity and encryption algorithms for a radio bearer, and a means for sending a radio resource control connection reconfiguration message to the user equipment indicating the access stratum combined integrity and encryption algorithm selected for the radio bearer.

In an embodiment, user equipment is operatively coupled to a network. The user equipment comprises a means for receiving a non-access stratum security mode command message from an access and mobility management function, where the non-access stratum security mode command message indicates a non-access stratum combined integrity and encryption algorithm selected by the access and mobility management function. The user equipment further comprises a means for activating the non-access stratum combined integrity and encryption algorithm indicated in the non-access stratum security mode command message to protect non-access stratum signaling.

In an embodiment, the user equipment further comprises a means for receiving an access stratum security mode command message from a radio access network node, where the access stratum security mode command message indicates an access stratum combined integrity and encryption algorithm selected by the radio access network node. The user equipment further comprises a means for activating the access stratum combined integrity and encryption algorithm indicated in the access stratum security mode command message to protect radio resource control signaling.

In an embodiment, the user equipment further comprises a means for receiving a radio resource control connection reconfiguration message from the radio access network node, where the radio resource control connection reconfiguration message indicates an access stratum combined integrity and encryption algorithm selected by the radio access network node for a radio bearer. The user equipment further comprises a means for activating the access stratum combined integrity and encryption algorithm to protect user plane traffic over the radio bearer.

In an embodiment, a method of negotiating security mechanisms is disclosed. In a communication system comprising user equipment operatively coupled to a network, the method comprises identifying, at the network, security capabilities of the user equipment in supporting one or more combined integrity and encryption algorithms, selecting, at the network, a combined integrity and encryption algorithm from the one or more combined integrity and encryption algorithms, and sending a security negotiation message from the network to the user equipment indicating the combined integrity and encryption algorithm.

In an embodiment, the method further comprises receiving, at the user equipment, the security negotiation message from the network, and activating, at the user equipment, the combined integrity and encryption algorithm indicated in the security negotiation message to protect communications.

In an embodiment, the selecting comprises selecting an operating mode from multiple operating modes for the combined integrity and encryption algorithm, and the sending comprises sending the security negotiation message from the network to the user equipment indicating the combined integrity and encryption algorithm and the operating mode for the combined integrity and encryption algorithm.

In an embodiment, the method further comprises identifying additional authenticated data at the network, and identifying extra entropy data at the network. The sending comprises sending the security negotiation message from the network to the user equipment containing at least one of the additional authenticated data and the extra entropy data.

In an embodiment, the security negotiation message comprises a security mode command message.

In an embodiment, the identifying comprises receiving a non-access stratum message from the user equipment that indicates the one or more combined integrity and encryption algorithms supported by the user equipment, and a user equipment security capability information element of the non-access stratum message is extended to indicate the one or more combined integrity and encryption algorithms supported by the user equipment.

In an embodiment, for a non-access stratum security procedure between the user equipment and an access and mobility management function, the selecting comprises selecting, at the access and mobility management function, a non-access stratum combined integrity and encryption algorithm from the one or more combined integrity and encryption algorithms, and the sending comprises sending a non-access stratum security mode command message from the access and mobility management function to the user equipment indicating the non-access stratum combined integrity and encryption algorithm.

In an embodiment, the receiving comprises receiving, at the user equipment, the non-access stratum security mode command message indicating the non-access stratum combined integrity and encryption algorithm, and the activating comprises activating, at the user equipment, the non-access stratum combined integrity and encryption algorithm to protect non-access stratum signaling.

In an embodiment, a non-access stratum security algorithms information element of the non-access stratum security mode command message is extended to indicate the non-access stratum combined integrity and encryption algorithm.

In an embodiment, the non-access stratum combined integrity and encryption algorithm supports multiple operating modes, and the non-access stratum security mode command message is extended to indicate an operating mode selected from the multiple operating modes for the non-access stratum combined integrity and encryption algorithm.

In an embodiment, the non-access stratum combined integrity and encryption algorithm uses at least one of additional authenticated data and extra entropy data as input parameters to generate a non-access stratum message authentication code, and the non-access stratum security mode command message is extended to contain at least one of the additional authenticated data and the extra entropy data.

In an embodiment, the additional authentication data comprises one of a 5G temporary mobile subscriber identity, TMSI, of the user equipment, a truncated 5G-S-TMSI, or network slice selection assistance information.

In an embodiment, the extra entropy data comprises a random number generated by the access and mobility management function.

In an embodiment, for an access stratum security procedure between the user equipment and a radio access network node, the selecting comprises selecting, at the radio access network node, an access stratum combined integrity and encryption algorithm from the one or more combined integrity and encryption algorithms, and the sending comprises sending an access stratum security mode command message from the radio access network node to the user equipment indicating the access stratum combined integrity and encryption algorithm.

In an embodiment, the receiving comprises receiving, at the user equipment, the access stratum security mode command message indicating the access stratum combined integrity and encryption algorithm, and the activating comprises activating, at the user equipment, the access stratum combined integrity and encryption algorithm to protect radio resource control signaling.

In an embodiment, a security algorithm configuration information element of the access stratum security mode command message is extended to indicate the access stratum combined integrity and encryption algorithm.

In an embodiment, the access stratum combined integrity and encryption algorithm supports multiple operating modes, and the security algorithm configuration information element is extended to indicate an operating mode selected from the multiple operating modes for the access stratum combined integrity and encryption algorithm.

In an embodiment, the access stratum combined integrity and encryption algorithm uses at least one of additional authenticated data and extra entropy data as input parameters to generate a message authentication code, and the security algorithm configuration information element is extended to contain at least one of the additional authenticated data and the extra entropy data.

In an embodiment, the additional authentication data comprises at least one of a radio network temporary identifier, and a physical cell identifier.

In an embodiment, the extra entropy data comprises a random number generated by the radio access network node.

In an embodiment, after radio resource control security is activated as part of the access stratum security procedure between the user equipment and the radio access network node, the method further comprises selecting, at the radio access network node, an access stratum combined integrity and encryption algorithm from the one or more combined integrity and encryption algorithms for a radio bearer, and sending a radio resource control connection reconfiguration message from the radio access network node to the user equipment indicating the access stratum combined integrity and encryption algorithm selected for the radio bearer.

In an embodiment, the method further comprises receiving, at the user equipment, the radio resource control connection reconfiguration message indicating the access stratum combined integrity and encryption algorithm selected for the radio bearer, and activating, at the user equipment, the access stratum combined integrity and encryption algorithm to protect user plane traffic over the radio bearer.

In an embodiment, a security algorithm configuration field of the radio resource control connection reconfiguration message is extended to indicate the access stratum combined integrity and encryption algorithm.

In an embodiment, the access stratum combined integrity and encryption algorithm supports multiple operating modes and the security algorithm configuration field is extended to indicate an operating mode selected from the multiple operating modes for the access stratum combined integrity and encryption algorithm.

In an embodiment, the access stratum combined integrity and encryption algorithm uses at least one of additional authenticated data and extra entropy data as input parameters to generate a message authentication code, and the security algorithm configuration field is extended to contain at least one of the additional authenticated data and the extra entropy data.

Other embodiments may include computer readable media, other systems or apparatus, or other methods as described below. Also, one or more embodiments as described above may be combinable as described herein.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a high-level architecture of a 5G system.

FIG. 2 illustrates a non-roaming architecture of a 5G system.

FIG. 3 illustrates security mechanisms within a 5G system.

FIGS. 4A-4B illustrate the primary authentication procedure that provides mutual authentication between user equipment and the network.

FIG. 5 illustrates non-access stratum (NAS) and access stratum (AS) security procedures.

FIG. 6 illustrates user plane (UP) security activation.

FIG. 7 illustrates a key hierarchy of a 5G system.

FIG. 8 illustrates an integrity algorithm (NIA).

FIG. 9 illustrates a ciphering or encryption algorithm (NEA).

FIG. 10A illustrates a combined algorithm (NCA) in an illustrative embodiment.

FIG. 10B illustrates a NAS combined algorithm (NAS NCA) in an illustrative embodiment.

FIG. 10C illustrates an AS combined algorithm (AS NCA) in an illustrative embodiment.

FIG. 10D is a block diagram illustrating different operating modes of a combined algorithm in an illustrative embodiment.

FIG. 11 illustrates an enhanced key hierarchy of a 5G system in an illustrative embodiment.

FIG. 12 is a block diagram illustrating an algorithm key derivation function (KDF) in an illustrative embodiment.

FIG. 13 illustrates a table of algorithm type distinguishers in an illustrative embodiment.

FIG. 14 is a block diagram of user equipment (UE) in an illustrative embodiment.

FIG. 15 is a block diagram of an AMF in an illustrative embodiment.

FIG. 16 is a block diagram of a RAN node in an illustrative embodiment.

FIG. 17 illustrates a NAS functional layer and AS functional layer of a 5G system in an illustrative embodiment.

FIGS. 18A-18E are flow charts illustrating methods of performing security mechanisms in a 5G system in illustrative embodiments.

FIG. 19 illustrates a NAS functional layer and AS functional layer in a 5G system in an illustrative embodiment.

FIGS. 20A-20B are flow charts illustrating a method of negotiating security mechanisms in an illustrative embodiment.

FIG. 21 is a signaling diagram illustrating negotiation of security mechanisms in an illustrative embodiment.

FIGS. 22A-22B are flow charts illustrating a method of negotiating NAS security mechanisms in an illustrative embodiment.

FIG. 23 is a signaling diagram illustrating a NAS security procedure between a UE and AMF of a 5G network in an illustrative embodiment.

FIG. 24 is a block diagram illustrating the NAS security algorithms Information Element (IE).

FIG. 25 is a block diagram illustrating an extension to the coding for the NAS security algorithms IE in an illustrative embodiment.

FIG. 26 is a block diagram illustrating NAS security mode command message content in an illustrative embodiment.

FIG. 27 is a block diagram illustrating an additional 5G AEAD security information IE in an illustrative embodiment.

FIG. 28 illustrates a coding for the additional 5G AEAD security information IE in an illustrative embodiment.

FIGS. 29A-29B are flow charts illustrating a method of performing an RRC security mechanism in an illustrative embodiment.

FIG. 30 is a signaling diagram illustrating an RRC security procedure between a UE and a gNB in an illustrative embodiment.

FIG. 31 illustrates the message content of an AS security mode command message.

FIG. 32 illustrates a security algorithm configuration IE in an illustrative embodiment.

FIGS. 33A-33B are flow charts illustrating a method of performing a UP security procedure in an illustrative embodiment.

FIG. 34 is a signaling diagram illustrating a UP security procedure between a UE and a gNB in an illustrative embodiment.

FIG. 35 illustrates the message content of an RRC connection reconfiguration message in an illustrative embodiment.

FIG. 36 is a block diagram illustrating the UE security capability IE.

FIG. 37 is a block diagram illustrating an extension to the coding for the UE security capability IE in an illustrative embodiment.

FIGS. 38A-38B illustrate two integrity modes in an illustrative embodiment.

FIG. 39 is a signaling diagram illustrating NAS and AS security procedures in an illustrative embodiment.

FIG. 40 is a signaling diagram illustrating NAS and AS security procedures in an illustrative embodiment.

FIG. 41 is a signaling diagram illustrating NAS and AS security procedures in an illustrative embodiment.

FIGS. 42A-42B illustrate derivation of extra entropy data in illustrative embodiments.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

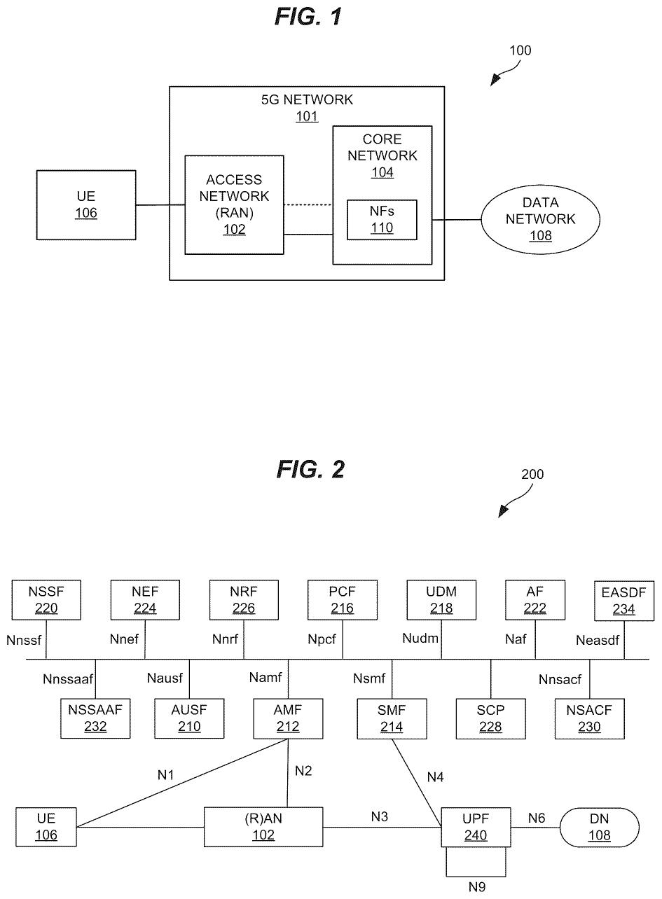

FIG. 1 illustrates a high-level architecture of a 5G system 100. A 5G system (5GS) 100 is a communication system (e.g., a 3GPP system) comprising a 5G Access Network ((R)AN) 102 (referred to generally herein as a RAN) and a 5G core network (5GC) 104 that communicate with 5G User Equipment (UE) 106. The RAN 102 and 5GC 104 together may be referred to as a 5G network 101, a 5G mobile network, a 5G communication network, etc. Although the term “5G” is used herein, any next generation networks beyond 5G are also considered.

RAN 102 provides radio or wireless connectivity to a UE 106, and connects the UE 106 to the 5GC 104. RAN 102 may comprise a Next Generation Radio Access Network (NG-RAN), a non-3GPP access network, and/or another type of RAN connecting to 5GC 104. RAN 102 may support Evolved-UMTS Terrestrial Radio Access Network (E-UTRAN) access (e.g., through an eNodeB (eNB), gNodeB (gNB), and/or ng-eNodeB (ng-eNB)), Wireless Local Area Network (WLAN) access, satellite radio access, new Radio Access Technologies (RAT), etc. A 5G access network may also support fixed access. 5GC 104 interconnects RAN 102 with a data network (DN) 108. 5GC 104 is comprised of Network Functions (NF) 110, which may be implemented either as a network element on dedicated hardware, as a software instance running on dedicated hardware, as a virtualized function instantiated on an appropriate platform (e.g., a cloud infrastructure), etc. Data network 108 may be an operator external public or private data network, or an intra-operator data network (e.g., for IP Multimedia Subsystem (IMS) services). A UE 106 (also referred to as a mobile terminal) includes a 5G capable device configured to register with 5GC 104 to access services. UE 106 may include an end user device, such as a mobile phone (e.g., smartphone), a tablet, a computer with a mobile broadband adapter, etc. UE 106 may be enabled for voice services, data services, Machine-to-Machine (M2M) or Machine Type Communications (MTC) services, and/or other services.

FIG. 2 illustrates a non-roaming architecture 200 of a 5G system 100. The architecture 200 in FIG. 2 is a service-based representation, as is further described in 3GPP TS 23.501 (v18.2.0), which is incorporated by reference as if fully included herein. Architecture 200 is comprised of Network Functions (NF) for a 5GC 104, and the NFs for the control plane (CP) are separated from the user plane (UP). The control plane of the 5GC 104 includes an Authentication Server Function (AUSF) 210, an Access and Mobility Management Function (AMF) 212, a Session Management Function (SMF) 214, a Policy Control Function (PCF) 216, a Unified Data Management (UDM) 218, a Network Slice Selection Function (NSSF) 220, and an Application Function (AF) 222. The control plane of the 5GC 104 further includes a Network Exposure Function (NEF) 224, a NF Repository Function (NRF) 226, a Service Communication Proxy (SCP) 228, a Network Slice Admission Control Function (NSACF) 230, a Network Slice-specific and SNPN Authentication and Authorization Function (NSSAAF) 232, and an Edge Application Server Discovery Function (EASDF) 234. The user plane of the 5GC 104 includes one or more User Plane Functions (UPF) 240 that communicate with data network 108. A UE 106 is able to access the control plane and the user plane of the 5GC 104 through RAN 102.

There are a large number of subscribers that are able to access services from a carrier or home network operator that implements a mobile network comprising a 5G system 100, such as in FIGS. 1-2. Communications between the subscribers (i.e., through a UE) and the mobile network are protected by security mechanisms, such as the ones standardized by the 3GPP. Subscribers and the carrier expect security guarantees from the security mechanisms.

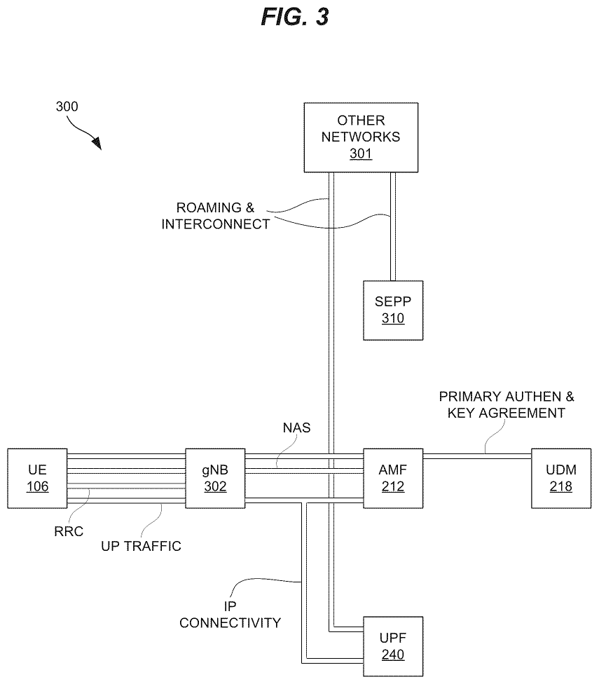

FIG. 3 illustrates security mechanisms 300 within a 5G system 100. One of the security mechanisms 300 is primary authentication and key agreement between the network (e.g., AMF 212/UDM 218) and the UE 106. Other security mechanisms 300 are used to protect signaling between the network and the UE 106. For example, a security mechanism 300 is used to protect Non-Access Stratum (NAS) signaling between the AMF 212 and the UE 106. Another security mechanism 300 is used to protect Radio Resource Control (RRC) signaling between a gNB 302 and the UE 106. A security mechanism 300 may also be used to protect User Plane (UP) traffic (also referred to as UP data) between the gNB 302 and the UE 106. Within the network, a security mechanism 300 may be used to protect IP connectivity between the gNB 302 and the 5GC 104 (e.g., AMF 212/UPF 240), such as Internet Protocol Security (IPSec). Yet another security mechanism 300 is used for roaming and interconnect security, such as to protect control plane signaling between a Security Edge Protection Proxy (SEPP) 310 and another network 301 (e.g., a visited 5G network), and/or to protect user plane data between the UPF 240 and the other network 301. There may be additional security mechanisms 300 defined or used, which are not discussed for the sake of brevity.

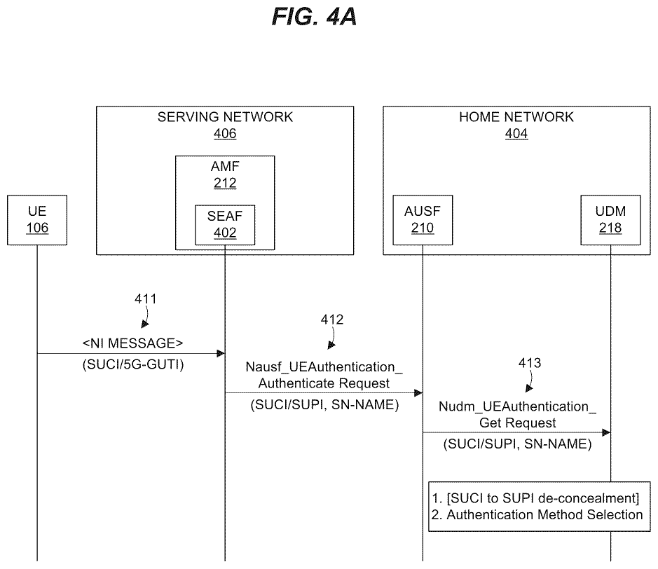

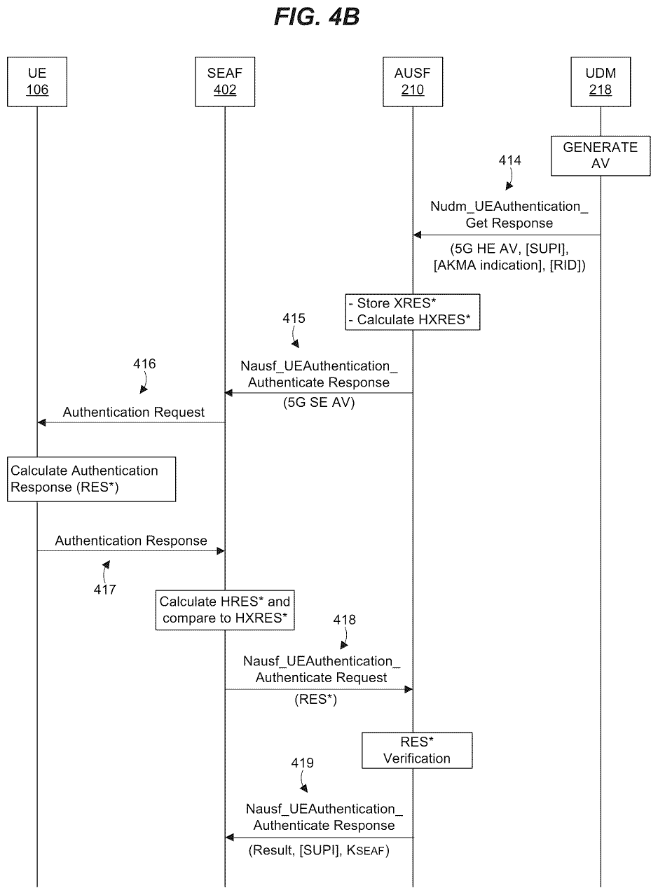

FIGS. 4A-4B illustrate the primary authentication procedure that provides mutual authentication between the UE 106 and the network (e.g., AMF 212/UDM 218). The purpose of the primary authentication and key agreement procedures is to enable mutual authentication between UE 106 and the home network of the UE 106, and provide keying material that can be used between the UE 106 and the serving network in subsequent security procedures (e.g., NAS and AS security procedures). The home network (e.g., Home Public Land Mobile Network (HPLMN)) represents an operator network or carrier network through which a subscriber (e.g., UE 106) has a subscription for services. The serving network has radio access equipment able to communicate with the UE 106 via radio signals. The keying material generated by the primary authentication and key agreement procedure results in an anchor key (called the K_{SEAF} key) provided by the AUSF 210 of the home network to the Security Anchor Function (SEAF) of the serving network. The SEAF provides authentication functionality via the AMF 212 in the serving network, and supports primary authentication using a Subscription Concealed Identifier (SUCI) that contains the concealed Subscription Permanent Identifier (SUPI). The SUPI is a globally unique 5G identifier allocated to each subscriber in the 5G system 100. The SUCI is composed of a SUPI type, a Home Network Identifier (HN-ID) identifying the home network of the subscriber, a Routing Indicator (RID) that is assigned to the subscriber by the home network operator and provisioned in the Universal Subscriber Identity Module (USIM) of the UE 106, a Protection Scheme Identifier, a Home Network Public Key Identifier, and a Scheme Output. The anchor key (K_{SEAF}) is derived from an intermediate key called the K_{AUSF} key. The K_{AUSF} key is established between the UE 106 and the home network (AUSF 210) resulting from the primary authentication procedure.

FIG. 4A is a signaling diagram that illustrates initiation of primary authentication, such as described in 3GPP TS 33.501 (v18.2.0), which is incorporated by reference as if fully included herein. The UE 106 transmits an N1 message 411 (i.e., an initial NAS message) to the serving network 406 (e.g., the AMF 212 of the serving network 406), such as a Registration Request. The serving network 406 may also be referred to as a serving PLMN, a visited-PLMN (VPLMN), etc., in a roaming scenario. The UE 106 uses the SUCI or a 5G Global Unique Temporary Identifier (5G-GUTI) in the Registration Request. SEAF 402 of the AMF 212 may initiate an authentication with the UE 106 during any procedure establishing a signaling connection with the UE 106. SEAF 402 invokes the Nausf_UEAuthentication service toward the home network 404 (e.g., HPLMN) by sending a Nausf_UEAuthentication_Authenticate Request message 412 to AUSF 210 to initiate an authentication. The Nausf_UEAuthentication_Authenticate Request message 412 includes the SUCI or SUPI, and the serving network name (SN-Name). Upon receiving the Nausf_UEAuthentication_Authenticate Request message 412, AUSF 210 checks that the requesting SEAF 402 in the serving network 406 is entitled to use the serving network name (SNN) in the Nausf_UEAuthentication_Authenticate Request message 412 by comparing the serving network name with the expected serving network name. When the serving network 406 is authorized to use the serving network name, AUSF 210 sends a Nudm_UEAuthentication_Get Request message 413 to UDM 218 of the home network. The Nudm_UEAuthentication_Get Request message 413 includes the SUCI or SUPI, and the serving network name. Upon reception of the Nudm_UEAuthentication_Get Request message 413, UDM 218 identifies the SUPI (if received), or invokes a Subscription Identifier De-concealing Function (SIDF) that de-conceals the SUPI from the SUCI (if received). UDM 218 (or an Authentication credential Repository and Processing Function (ARPF) of UDM 218) selects or chooses the authentication method for primary authentication based on the SUPI.

FIG. 4B is a signaling diagram that illustrates a primary authentication procedure, such as described in 3GPP TS 33.501. In this example, 5G Authentication and Key Agreement (AKA) is described, but similar concepts apply for Extensible Authentication Protocol AKA prime (EAP-AKA′). For a Nudm_UEAuthentication_Get Request 413, UDM 218 creates a 5G Home Environment Authentication Vector (5G HE AV) for the selected authentication method. UDM 218 derives the K_{A}US_{F} key and calculates an expected response (XRES*) to a challenge. UDM 218 creates the 5G HE AV comprising an authentication token (AUTN), the expected response (XRES*), the K_{A}US_{F} key, and a random challenge (RAND). UDM 218 then sends a Nudm_UEAuthentication_Get Response message 414 to AUSF 210 with the 5G HE AV to be used for authentication (e.g., 5G AKA in FIG. 4B). In case the SUCI was included in the Nudm_UEAuthentication_Get Request 413, UDM 218 includes the SUPI in the Nudm_UEAuthentication_Get Response message 414 after de-concealment of the SUPI from the SUCI. If a subscriber has an Authentication and Key Management for Application (AKMA) subscription, UDM 218 may include an AKMA indication and the RID in the Nudm_UEAuthentication_Get Response message 414.

In response to the Nudm_UEAuthentication_Get Response message 414, AUSF 210 stores the expected response (XRES*) temporarily with the received SUCI or SUPI. AUSF 210 then generates a 5G Authentication Vector (5G AV) from the 5G HE AV received from UDM 218, by computing a hash expected response (HXRES*) from the expected response (XRES*) and the K_{SEAF} key from the K_{A}US_{F} key, and replacing the XRES* with the HXRES* and the K_{A}US_{F} key with the K_{SEAF} key in the 5G HE AV. AUSF 210 removes the K_{SEAF} key to generate a 5G Serving Environment Authentication Vector (5G SE AV) that includes the authentication token (AUTN), hash expected response (HXRES*), and the random challenge (RAND). AUSF 210 sends a Nausf_UEAuthentication_Authenticate Response message 415 to SEAF 402 that includes the 5G SE AV. In response, SEAF 402 sends the authentication token (AUTN) and the random challenge (RAND) to the UE 106 in a NAS message Authentication Request message 416.

Although not shown in FIG. 4B, the UE 106 includes Mobile Equipment (ME) and a USIM. The ME receives the authentication token (AUTN) and the random challenge (RAND) in the NAS message Authentication Request message 416, and forwards the authentication token (AUTN) and the random challenge (RAND) to the USIM. The USIM of the UE 106 verifies the freshness of the received values by checking whether the authentication token (AUTN) can be accepted. If so, the USIM computes a response (RES), a cipher key (CK), and an integrity key (IK) based on the random challenge (RAND), and returns the response (RES), the CK key, and the IK key to the ME. The ME of the UE 106 computes RES* from RES, and calculates the K_{A}US_{F} key from CKI∥IK and the K_{SEAF} key from the K_{AUSF} key.

The UE 106 sends a NAS message Authentication Response message 417 to SEAF 402 that includes RES*. In response, SEAF 402 computes HRES* from RES*, and compares HRES* and HXRES*. If they coincide, SEAF 402 considers the authentication successful from the serving network point of view. SEAF 402 sends RES*, as received from the UE 106, in a Nausf_UEAuthentication_Authenticate Request message 418 to AUSF 210. When AUSF 210 receives the Nausf_UEAuthentication_Authenticate Request message 418 including a RES* as authentication confirmation, AUSF 210 stores the K_{AUSF} key based on the home network operator's policy, and compares the received RES* with the stored XRES*. If the RES* and XRES* are equal, then AUSF 210 considers the authentication successful from the home network point of view. AUSF 210 informs UDM 218 about the authentication result (not shown). AUSF 210 also sends a Nausf_UEAuthentication_Authenticate Response message 419 to SEAF 402 indicating whether or not the authentication was successful from the home network point of view. If the authentication was successful, the K_{SEAF} key is sent to SEAF 402 in the Nausf_UEAuthentication_Authenticate Response message 419. In case AUSF 210 received the SUCI from SEAF 402 in the authentication request, AUSF 210 includes the SUPI in the Nausf_UEAuthentication_Authenticate Response message 419 if the authentication was successful.

As described above, 5G divides UE management into the Non-Access Stratum (NAS) and the Access Stratum (AS). The NAS layer protocol manages the connection between a UE 106 and 5GC 104 (i.e., AMF 212), and the AS layer protocol manages the radio layer between a UE 106 and the RAN 102 (e.g., gNB 302) using RRC protocol. NAS security ensures that NAS signaling between a UE 106 and AMF 212 is protected on the control plane, and AS security ensures that RRC messages on the control plane and user plane traffic (e.g., IP packets) on the user plane are protected.

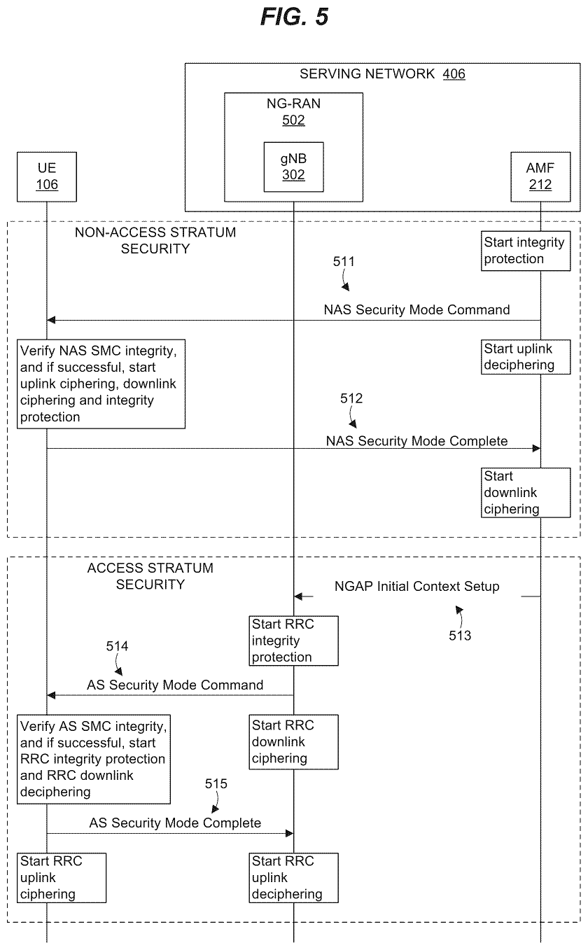

FIG. 5 illustrates NAS and AS security procedures, such as described in 3GPP TS 33.501 (sections 6.4 and 6.7, respectively). For NAS security, a NAS security mode command procedure is performed to establish a NAS security context between the UE 106 and the AMF 212. Each AMF 212 is configured via network management with lists of algorithms that are allowed for usage. Presently, there is one list for NAS integrity algorithms and one for NAS ciphering algorithms that are ordered according to a priority decided by the operator. To establish the NAS security context, AMF 212 selects one NAS ciphering algorithm and one NAS integrity protection algorithm, and derives the NAS integrity key and the NAS encryption key (e.g., K_{NASint} and K_{NASenc}) for the selected algorithms. AMF 212 initiates the NAS security mode command procedure by sending a NAS Security Mode Command message 511 to the UE 106. AMF 212 activates NAS integrity protection before sending the NAS Security Mode Command message 511. The NAS Security Mode Command message 511 contains the previously received UE security capabilities, the selected NAS algorithms, a key set identifier (i.e., ngKSI (next generation key set identifier)), and a message authentication code (NAS-MAC) generated by the AMF 212 for integrity protection of the NAS Security Mode Command message 511. The NAS Security Mode Command message 511 is integrity protected (but not ciphered) with the NAS integrity key based on the K_{AMF} key indicated by the ngKSI. AMF 212 activates NAS uplink de-ciphering after sending the NAS Security Mode Command message 511.

On receipt of the NAS Security Mode Command message 511, the UE 106 verifies the integrity of the NAS Security Mode Command using the indicated NAS integrity algorithm and the NAS integrity key based on the K_{AMF} key indicated by the ngKSI. The UE 106, with the received algorithms, generates the NAS integrity key and the NAS encryption key in the same manner as AMF 212. If verification is successful, the UE 106 begins NAS integrity protection and ciphering/deciphering with the security context indicated by the ngKSI. The UE 106 sends a NAS Security Mode Complete message 512 to AMF 212 that is ciphered and integrity protected. If the verification of the NAS Security Mode Command message 511 is not successful, the UE 106 replies with a NAS Security Mode Reject message (not shown).

AMF 212 de-ciphers and checks the integrity of the received NAS Security Mode Complete message 512 using the key and algorithm indicated in the NAS Security Mode Command message 511. AMF 212 activates NAS downlink ciphering after receiving the NAS Security Mode Complete message 512.

AS security includes RRC security and User Plane (UP) security. For RRC security, RRC integrity protection and RRC confidentiality protection are provided by the Packet Data Convergence Protocol (PDCP) layer between a UE 106 and a gNB 302. For UP security, the SMF 214 provides a UP security policy for a Packet Data Unit (PDU) session to the gNB 302 (or ng-eNB) during the PDU session establishment procedure (not shown). The UP security policy indicates whether UP confidentiality and/or UP integrity protection are activated for Data Radio Bearers (DRBs) belonging to that PDU session.

An AS security mode command procedure is performed to establish an AS security context between the UE 106 and the NG-RAN 502. When the AS security context is to be established in the gNB 302, AMF 212 sends the UE 5G security capabilities with ciphering and integrity protected algorithms and the K_{gNB} key in an NG Application Protocol (NGAP) Initial Context Setup message 513 to the NG-RAN 502 (e.g., gNB 302). Presently, each gNB 302 is configured via network management with lists of algorithms that are allowed for usage. There is one list for integrity algorithms and one for ciphering algorithms that are ordered according to a priority decided by the operator. The gNB 302 selects the AS integrity algorithm and the AS ciphering algorithm which has the highest priority from its configured list and present in the UE 5G security capabilities received from AMF 212. The gNB 302 derives the RRC integrity key (K_{RRCint}), the UP integrity key (K_{UPint}), the RRC ciphering key (K_{RRCenc}), and the UP ciphering key (K_{UPenc}) for the selected AS algorithms. The gNB 302 starts integrity protection for RRC messages.

The gNB 302 sends an integrity protected AS Security Mode Command message 514 to the UE 106, which contains the selected AS integrity algorithm and AS ciphering algorithm, and the message authentication code (MAC-I) generated by the gNB 302 for integrity protection of the AS Security Mode Command message 514. RRC downlink ciphering at the gNB 302 starts after sending the AS Security Mode Command message 514.

On receipt of the AS Security Mode Command message 514, the UE 106 derives the RRC integrity key (K_{RRCint}) and the RRC ciphering key (K_{RRCenc}) Similar to the gNB 302 based on the selected AS integrity algorithm and AS ciphering algorithm. UE 106 verifies the AS Security Mode Command integrity and, if successful, starts RRC integrity protection and RRC downlink de-ciphering. The UE 106 then sends an AS Security Mode Complete message 515 with integrity protection to the gNB 302. The AS Security Mode Complete message 515 contains the MAC-I generated by UE 106 for integrity protection of the AS Security Mode Complete message 515. The RRC uplink ciphering at the UE 106 starts after sending the AS Security Mode Complete message 515. Integrity of the AS Security Mode Complete message 515 is verified at the gNB 302, and the gNB 302 starts RRC uplink deciphering.

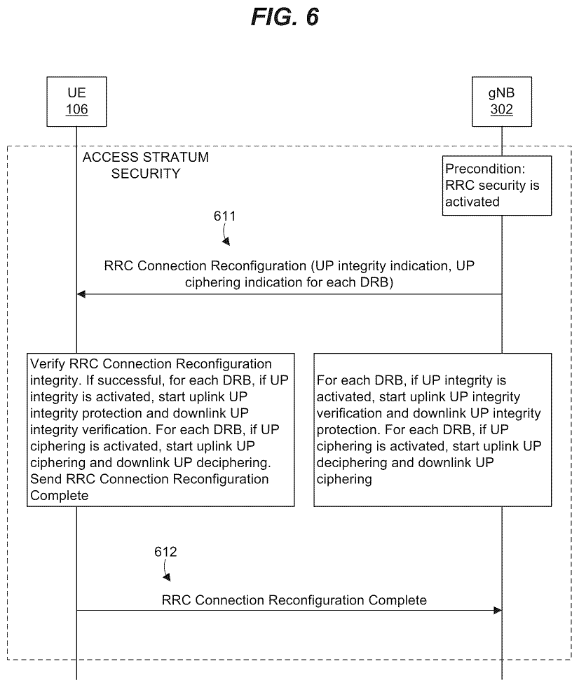

Further, as part of AS security, FIG. 6 illustrates UP security activation. The AS UP integrity protection and ciphering activation is done as part of the DRB addition procedure using the RRC Connection Reconfiguration procedure. The RRC Connection Reconfiguration procedure, which is used to add DRBs, is performed after RRC security has been activated as part of the AS security mode command procedure. The gNB 302 sends an RRC Connection Reconfiguration message 611 to the UE 106 for UP security activation. The RRC Connection Reconfiguration message 611 contains indications for the activation of UP integrity protection and UP ciphering for each DRB according to the security policy. If UP integrity protection is activated for DRBs as indicated in the RRC Connection Reconfiguration message 611 and the gNB 302 does not have the K_{UPint} key, the gNB 302 derives the K_{UPint} key and UP integrity protection for the DRBs starts at the gNB 302. Similarly, if UP ciphering is activated for DRBs as indicated in the RRC Connection Reconfiguration message 611 and the gNB 302 does not have the K_{UPenc} key, the gNB 302 derives the K_{UPenc} key and UP ciphering for DRBs starts at the gNB 302.

On receipt of the RRC Connection Reconfiguration message 611, the UE 106 verifies the RRC Connection Reconfiguration integrity protection. If successful, the UE 106 performs the following. When UP integrity protection is activated for DRBs as indicated in the RRC Connection Reconfiguration message 611 and the UE 106 does not have the K_{UPint} key, the UE 106 derives the K_{UPint} key and UP integrity protection for DRBs starts at the UE 106. Similarly, when UP ciphering is activated for DRBs as indicated in the RRC Connection Reconfiguration message 611 and the UE 106 does not have the K_{UPenc} key, the UE 106 derives the K_{UPenc} key and UP ciphering for DRBs starts at the UE 106. The UE 106 sends an RRC Connection Reconfiguration Complete message 612 to the gNB 302.

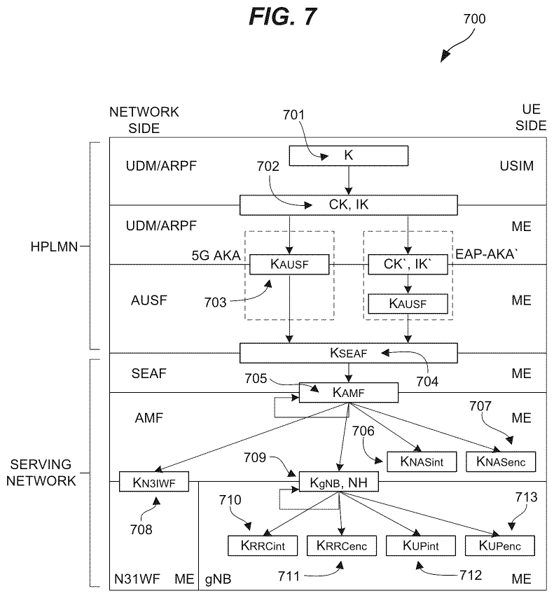

FIG. 7 illustrates a key hierarchy 700 of a 5G system 100, such as in 3GPP TS 33.501 (section 6.2). The keys related to authentication include the following keys: K 701, and CK/IK 702. The key hierarchy 700 includes the following keys: K_{AUSF} 703, K_{SEAF} 704, K_{AMF} 705, K_{NASint} 706, K_{NASenc} 707, K_{N3IWF} 708, K_{gNB} 709, K_{RRCint} 710, K_{RRCenc} 711, K_{UPint} 712, and K_{UPenc} 713. The keys for AUSF 210 in the home network 404 include the K_{AUSF} key 703 derived by the ME of a UE 106 and AUSF 210 from CK′, IK′ in case of EAP-AKA′, or by the ME and the ARPF of UDM 218 from CK, IK 702 in case of 5G AKA. The K_{SEAF} key 704 is the anchor key derived by the ME and AUSF 210 from the K_{AUSF} key 703. The key for AMF 212 in the serving network 406 is the K_{AMF} key 705 derived by the ME and the SEAF 402 from the K_{SEAF} key 704. The keys for NAS signaling (i.e., of a NAS security context) include the K_{NASint} key 706 derived by the ME and AMF 212 from the K_{AMF} key 705, which is used for integrity protection of NAS signaling with a particular integrity algorithm. The keys for NAS signaling also include the K_{NASenc} key 707 derived by the ME and AMF 212 from the K_{AMF} key 705, which is used for encryption of NAS signaling with a particular encryption algorithm. The key for the NG-RAN is the K_{gNB} key 709 derived by the ME and AMF 212 from the K_{AMF} key 705. For an AS security context, the keys for RRC signaling include the K_{RRCint} key 710 derived by the ME and the gNB 302 from the K_{gNB} key 709, which is used for integrity protection of RRC signaling with a particular integrity algorithm. The keys for RRC signaling further include the K_{RRCenc} key 711 derived by the ME and the gNB 302 from the K_{gNB} key 709, which is used for encryption of RRC signaling with a particular encryption algorithm. The keys for UP traffic include the K_{UPint} key 712 derived by the ME and the gNB 302 from the K_{gNB} key 709, which is used for integrity protection of UP traffic between the ME and the gNB 302 with a particular integrity algorithm. The keys for UP traffic further include the K_{UPenc} key 713 derived by the ME and the gNB 302 from the K_{gNB} key 709, which is used for encryption of UP traffic with a particular encryption algorithm. For non-3GPP access, the K_{N3IWF} key 708 is derived by the ME and the AMF 212 from the K_{AMF} key 705 for non-3GPP access. There are other keys as part of the key hierarchy 700 of a 5G system 100, which are not discussed for the sake of brevity.

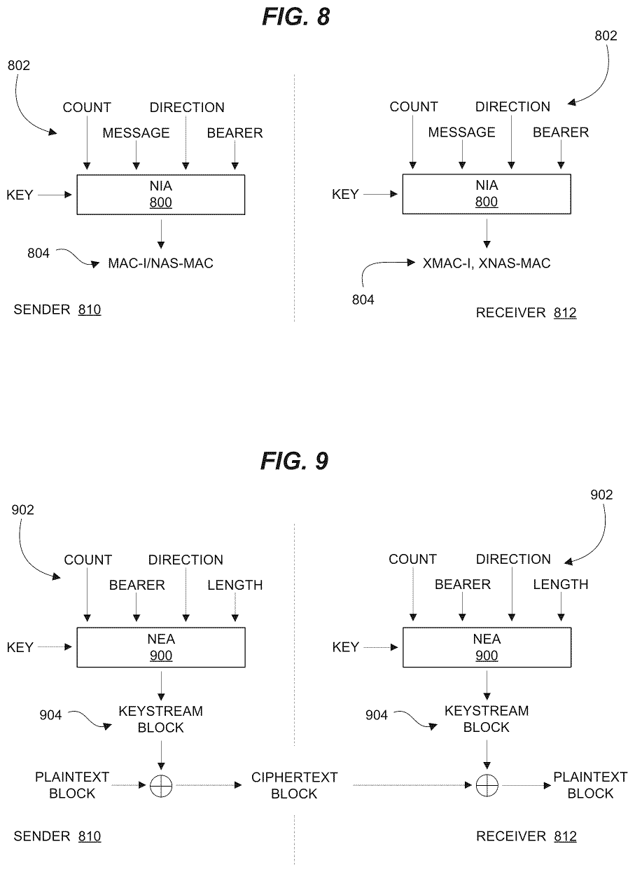

FIG. 8 illustrates an integrity algorithm (NIA) 800, such as shown in Annex D.3 of 3GPP TS 33.501. Presently, the input parameters 802 to the integrity algorithm 800 are a 128-bit integrity key named KEY, a 32-bit COUNT, a 5-bit bearer identity called BEARER, a 1-bit direction of the transmission (i.e., DIRECTION), and the message being integrity protected (i.e., MESSAGE). The DIRECTION bit is set to “0” for uplink and to “1” for downlink. The bit length of the MESSAGE is LENGTH. Based on the input parameters 802, a sender 810 computes a 32-bit message authentication code (MAC-I/NAS-MAC) as output 804 using the integrity algorithm 800. The MAC is then appended to the message when sent. For integrity protection algorithms, a receiver 812 computes the expected MAC (XMAC-I/XNAS-MAC) as output 804 on the message received in the same way as the sender 810 computed its MAC on the message sent, and verifies the data integrity of the message by comparing the computed MAC to the received MAC (i.e., MAC-I/NAS-MAC). Examples of 128-bit integrity algorithms 800 are 128-NIA1, 128-NIA2, and 128-NIA3.

FIG. 9 illustrates a ciphering or encryption algorithm (NEA) 900, such as shown in Annex D.2 of 3GPP TS 33.501. Presently, the input parameters 902 to the ciphering algorithm 900 are a 128-bit cipher key named KEY, a 32-bit COUNT, a 5-bit bearer identity BEARER, a 1-bit direction of the transmission (i.e., DIRECTION), and the length of the keystream required (i.e., LENGTH). The DIRECTION bit is set to “0” for uplink and to “1” for downlink. Based on the input parameters 902, the ciphering algorithm 900 generates as output 904, a keystream block (i.e., KEYSTREAM) which is used to encrypt a plaintext block (i.e., PLAINTEXT) to produce a ciphertext block (i.e., CIPHERTEXT). The keystream is applied to the plaintext block using a bit per bit binary addition of the plaintext and the keystream (XOR). The plaintext may be recovered by generating the same keystream using the same input parameters 902 and applying a bit per bit binary addition with the ciphertext. Examples of 128-bit ciphering algorithms 900 are 128-NEA1, 128-NEA2, and 128-NEA3.

There is a goal to continue to improve or enhance security mechanisms in 5G systems 100 and beyond. For example, security mechanisms may upgrade the 128-bit algorithms to 256-bit algorithms. Further, present security mechanisms utilize separate integrity algorithms (e.g., NIA 800 as in FIG. 8) and ciphering algorithms (e.g., NEA 900 in FIG. 9), which each use separate integrity code generation and ciphering step using separate keys. Embodiments described herein set forth enhanced security mechanisms that implement combined integrity and encryption algorithms in place of or in addition to separate integrity algorithms and ciphering algorithms. A combined integrity and encryption algorithm as described herein is configured to apply or provide ciphering/encryption and integrity protection using a single key. A combined integrity and encryption algorithm may also be referred to as a combined algorithm, a next-generation combined algorithm (NCA), a combined security algorithm, an Authenticated Encryption with Associated Data (AEAD) algorithm, etc.

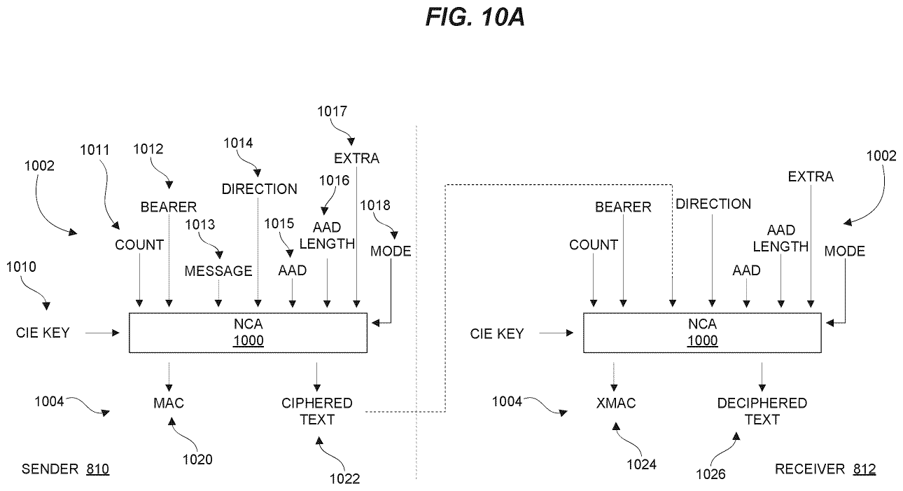

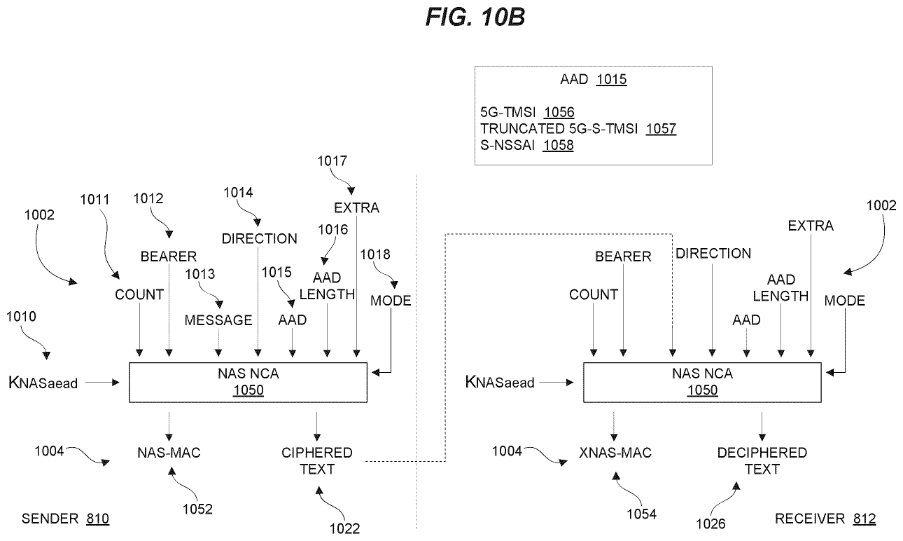

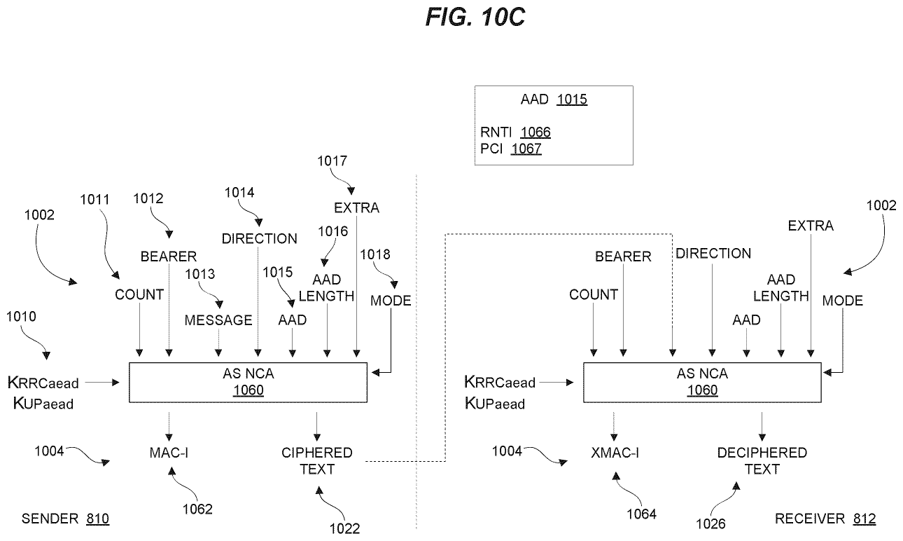

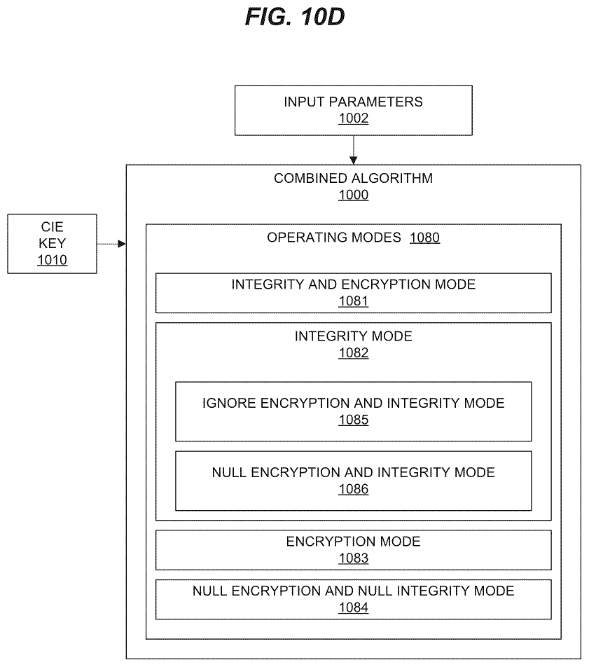

FIG. 10A illustrates a combined algorithm (NCA) 1000 in an illustrative embodiment. Combined algorithm 1000 is configured to generate output 1004 based on input parameters 1002. In an embodiment, the input parameters 1002 to the combined algorithm 1000 comprise a combined integrity and encryption (CIE) key 1010 (e.g., 256-bit), a 32-bit count 1011 (e.g., Uplink (UL) or Downlink (DL) count), a 5-bit bearer identity 1012, the message 1013 comprising plaintext to be ciphered or ciphered text to be deciphered, and a 1-bit direction 1014 (i.e., direction of transmission). The direction 1014 may be “0” for uplink, and “1” for downlink, for example.

In an embodiment, the input parameters 1002 may further comprise additional authenticated data (AAD) 1015, an AAD length 1016, extra entropy data 1017 (EXTRA), and an encryption/decryption mode 1018. The AAD 1015 comprises an identifier or information used in generation of a message authentication code (MAC) (e.g., with values between 0 and 232-1 bits). The AAD 1015 may be known to both the sender 810 and the receiver 812. The AAD 1015 may comprise an actual number of bits without padding to full bits, and may have a maximum of 32 bits in length. The AAD length 1016 indicates the length of the AAD 1015. The extra entropy data 1017 comprises a random number generated by the network (i.e., in the 5GC 104 or RAN 102), which used in generation of a MAC. The extra entropy data 1017 may be exchanged or shared with the UE 106 during a security mode command procedure. The extra entropy data 1017 may be 6 bytes in length. The encryption/decryption mode 1018 indicates whether the combined algorithm 1000 is used for encryption or decryption. For example, the encryption/decryption mode 1018 may be a 1-bit value of “0” for encrypt and “1” for decrypt.

At the sender 810, the combined algorithm 1000 computes a 32-bit MAC 1020 (e.g., MAC-I/NAS-MAC) and/or ciphered text 1022 as output 1004 based on the input parameters 1002. A range of MAC length values allowed in combined algorithm 1000 are “0” and “4 . . . 16”. The MAC 1020 is appended to the message when sent. For integrity protection, a receiver 812 computes an expected MAC 1024 (e.g., XMAC-I/XNAS-MAC) as output 1004 on the message received in the same way as the sender 810 computed its MAC 1020 on the message sent with the combined algorithm 1000, and verifies the data integrity of the message by comparing the expected MAC 1024 to the received MAC 1020. For ciphering protection, the combined algorithm 1000 generates ciphered text 1022 at the sender 810 based on the input parameters 1002. The plaintext may be recovered at the receiver 812 as deciphered text 1026 by inputting the ciphered text 1022 into the combined algorithm 1000. One technical benefit is a combined algorithm 1000 may be used for security mechanisms in place of or in addition to individual integrity algorithms and encryption algorithms.

FIG. 10B illustrates a NAS combined algorithm 1050 (NAS NCA) in an illustrative embodiment. The NAS combined algorithm 1050 is an example of a combined algorithm 1000 in FIG. 10A, and is used for NAS security mechanisms in protection of NAS signaling. NAS combined algorithm 1050 is configured to generate a NAS-MAC 1052 or XNAS-MAC 1054, and ciphered text 1022 or deciphered text 1026 based on the input parameters 1002 and a K_{NASaead} key. For the NAS combined algorithm 1050, the count 1011 may comprise the NAS count. The AAD 1015 may comprise information or an identifier known to both the AMF 212 and the UE 106. For example, the AAD 1015 may comprise a 5G Temporary Mobile Subscriber Identity (5G-TMSI) 1056, a truncated (i.e., 32 bits) 5G-S-TMSI 1057 (e.g., a truncated AMF set ID, truncated AMF pointer, and truncated 5G-TMSI), Network Slice Selection Assistance Information (S-NSSAI) 1058, etc. The extra entropy data 1017 may comprise a random number generated by the AMF 212, and exchanged or shared with the UE 106 during the NAS security mode command procedure. One technical benefit is a NAS combined algorithm 1050 may be used for NAS security mechanisms in place of or in addition to individual integrity algorithms and encryption algorithms.

FIG. 10C illustrates an AS combined algorithm 1060 (AS NCA) in an illustrative embodiment. The AS combined algorithm 1060 is an example of combined algorithm 1000 in FIG. 10A, and is used for RRC security mechanisms in protection of RRC signaling, and/or for UP security mechanism in protection of UP traffic. AS combined algorithm 1060 is configured to generate a MAC-I 1062 or XMAC-I 1064, and ciphered text 1022 or deciphered text 1026 based on the input parameters 1002 and a K_{RRCaead} key or a K_{UPaead} key. For the AS combined algorithm 1060, the count 1011 may comprise the PDCP count. The AAD 1015 may comprise information or an identifier known to both a gNB 302 and the UE 106. For example, the AAD 1015 may comprise a Radio Network Temporary Identifier (RNTI) 1066, a Physical Cell Identifier (PCI) 1067, a combination of the RNTI and PCI, etc. The extra entropy data 1017 may comprise a random number generated by the gNB 302, and exchanged or shared with the UE 106 during the AS security mode command procedure. Alternatively, the extra entropy data 1017 may comprise a random number generated by the AMF 212, and exchanged or shared with the UE 106 during the NAS security mode command procedure. One technical benefit is an AS combined algorithm 1060 may be used for RRC or UP security mechanisms in place of or in addition to individual integrity algorithms and encryption algorithms.

In an embodiment, one or more combined algorithms 1000 as described herein may support multiple operating modes. FIG. 10D is a block diagram illustrating different operating modes 1080 of a combined algorithm 1000 in an illustrative embodiment. Although a combined algorithm 1000 may be capable of or configured to perform both integrity protection and encryption using a (single) CIE key 1010, the combined algorithm 1000 may be coded to operate in at least the following operating modes 1080: integrity and encryption mode 1081, integrity mode 1082 without encryption, encryption mode 1083 without integrity protection, and NULL encryption and NULL integrity mode 1084. In integrity and encryption mode 1081, combined algorithm 1000 applies both encryption and integrity protection using the CIE key 1010. For example, combined algorithm 1000 may generate the integrity MAC using the ciphered data and non-ciphered data in a recursive manner. In integrity mode 1082, combined algorithm 1000 applies integrity protection to a plaintext message using the CIE key 1010, but ciphered data is not sent in a communication. In encryption mode 1083, combined algorithm 1000 applies ciphering to a plaintext message using the CIE key 1010, but a MAC is not sent in a communication, or if sent, is ignored by the receiver. In NULL encryption and NULL integrity mode 1084, combined algorithm 1000 neither applies ciphering nor integrity protection to a message.

Integrity mode 1082 may include different operating modes depending on the coding of the combined algorithm 1000. In an embodiment, integrity mode 1082 may include an ignore encryption and integrity mode 1085, where combined algorithm 1000 applies integrity protection and encryption to a plaintext message using the CIE key 1010, but the ciphered data is ignored. In an embodiment, integrity mode 1082 may include a NULL encryption and integrity mode 1086, where combined algorithm 1000 applies integrity protection and NULL encryption to a plaintext message using the CIE key 1010. With a NULL encryption setting, combined algorithm 1000 does not output ciphered data. Although some example operating modes 1080 were described above, other operating modes 1080 may be considered herein. One technical benefit is a combined algorithm 1000 may be used for different types protection (e.g., encryption only, integrity protection only, encryption and integrity protection, etc.).

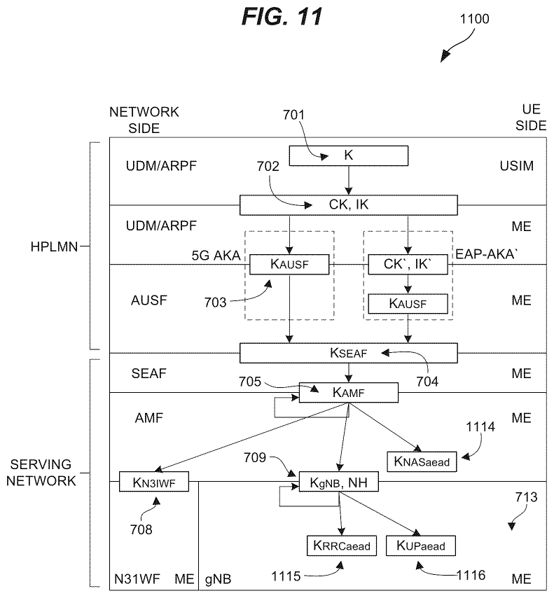

To maintain cryptographic isolation principles, the keys for the combined algorithms 1000 are different than the individual keys for encryption and for integrity protection. FIG. 11 illustrates an enhanced key hierarchy 1100 of a 5G system 100 in an illustrative embodiment. In this embodiment, the keys related to authentication include the following keys: K 701, and CK/IK 702. The key hierarchy 1100 includes the following keys: K_{A}US_{F}703, K_{SEAF} 704, K_{AMF} 705, K_{NASaead} 1114, K_{N3IWF} 708, K_{gNB} 709, K_{RRCaead} 1115, and K_{UPaead} 1116. The keys for AUSF 210 in the home network 404 include the K_{A}US_{F} key 703 derived by the ME of a UE 106 and AUSF 210 from CK′, IK′ in case of EAP-AKA′, or by the ME and the ARPF of UDM 218 from CK, IK 702 in case of 5G AKA. The K_{SEAF} key 704 is the anchor key derived by the ME and AUSF 210 from the K_{A}US_{F} key 703. The key for AMF 212 in the serving network 406 is the K_{AMF} key 705 derived by the ME and the SEAF 402 from the K_{SEAF} key 704. The key for NAS signaling (i.e., of a NAS security context) includes the K_{NASaead} key 1114 derived by the ME and the AMF 212 from the K_{AMF} key 705, which is used for the protection of NAS signaling between the ME and the gNB 302 with a particular combined algorithm 1000 (e.g., NAS combined algorithm 1050). The key for the NG-RAN is the K_{gNB} key 709 derived by the ME and AMF 212 from the K_{AMF} key 705. For an AS security context, the key for RRC signaling includes the K_{RRCaead} key 1115 derived by the ME and the gNB 302 from the K_{gNB} key 709, which is used for the protection of RRC signaling between the ME and the gNB 302 with a particular combined algorithm 1000 (e.g., AS combined algorithm 1060). The key for UP traffic includes the K_{UPaead} key 1116 derived by the ME and the gNB 302 from the K_{gNB} key 709, which is used for the protection of UP traffic between the ME and the gNB 302 with a particular combined algorithm 1000 (e.g., AS combined algorithm 1060). For non-3GPP access, the K_{N3IWF} key 708 is derived by the ME and the AMF 212 from the K_{AMF} key 705 for non-3GPP access. There may be other keys as part of the key hierarchy 1100 of a 5G system 100, which are not discussed for the sake of brevity.

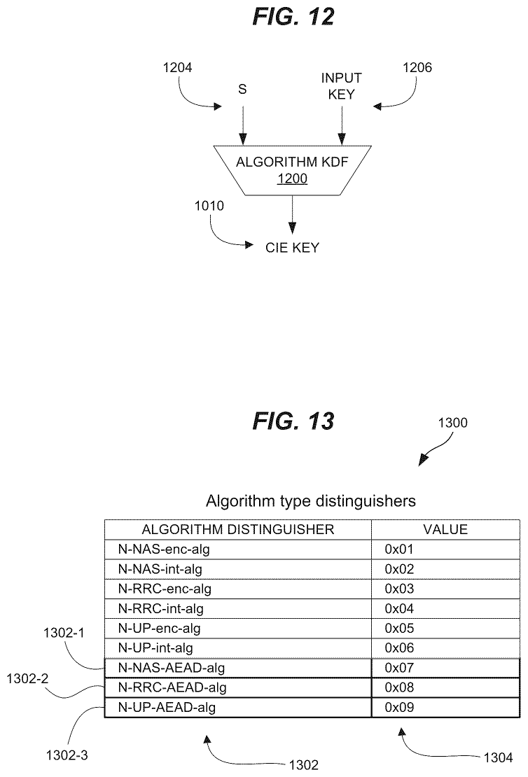

The K_{NASaead} key 1114, the K_{RRCaead} key 1115, and the K_{UPaead} key 1116 in key hierarchy 1100 may be referred to as CIE keys 1010, as they are used for protection of communications with a combined (integrity and encryption) algorithm 1000. FIG. 12 is a block diagram illustrating an algorithm key derivation function (KDF) 1200 in an illustrative embodiment, which is used to generate or derive CIE keys 1010. The input parameters to the algorithm KDF 1200 and their lengths are concatenated into a string S as: S=FC∥P0∥ L0∥ P1∥L1∥P2∥L2∥ P3∥L3∥ . . . ∥Pn∥Ln. FC is used to distinguish between different instances of the algorithm. P0 . . . Pn are the n+1 input parameter encodings, and L0 . . . Ln are the two-octet representations of the length of the corresponding input parameter encodings P0 . . . Pn. When deriving a CIE key 1010, the following input parameters may be used to form the string S 1204 that is input to algorithm KDF 1200:
FC=0x69,
P0=algorithm type distinguisher,
L0=length of algorithm type distinguisher (i.e., 0x00 0x01),
P1=algorithm identity,
L1=length of algorithm identity (i.e., 0x00 0x01).

When deriving the CIE key 1010 (i.e., the K_{NASaead} key 1114) for a NAS combined algorithm 1050 in the AMF 212 and the UE 106, the input key 1206 to the algorithm KDF 1200 is the Kaw key 705. When deriving the CIE key 1010 (i.e., the K_{RRCaead} key 1115 or the K_{UPaead} key 1116) for an AS combined algorithm 1060 in the gNB 302 and the UE 106, the input key 1206 to the algorithm KDF 1200 is the K_{gNB} key 709.

FIG. 13 illustrates a table 1300 of algorithm type distinguishers 1302 in an illustrative embodiment. For the algorithm KDF 1200 as described above, the algorithm type distinguisher 1302 is “N-NAS-enc-alg” for NAS encryption algorithms and “N-NAS-int-alg” for NAS integrity algorithms, and is “N-RRC-enc-alg” for RRC encryption algorithms, “N-RRC-int-alg” for RRC integrity algorithms, “N-UP-enc-alg” for UP encryption algorithms, and “N-UP-int-alg” for UP integrity algorithms, as described in Table A.8-1 of Annex A.8 of 3GPP TS 33.501. Table 1300 represents an enhancement to Table A.8-1 of Annex A.8, and includes additional algorithm type distinguishers 1302 for combined algorithms 1000. In an embodiment, a NAS algorithm type distinguisher 1302-1 (e.g., “N-NAS-AEAD-alg”) may be defined for NAS combined algorithms 1050, an RRC algorithm type distinguisher 1302-2 (e.g., “N-RRC-AEAD-alg”) may be defined for AS combined algorithms 1060 used to protect RRC signaling, and a UP algorithm type distinguisher 1302-3 (e.g., “N-UP-AEAD-alg”) may be defined for AS combined algorithms 1060 used to protect UP traffic. In this embodiment, the value 1304 for the NAS algorithm type distinguisher 1302-1 may be “0x07”, the value 1304 for the RRC algorithm type distinguisher 1302-2 may be “0x08”, and the value 1304 for the UP algorithm type distinguisher 1302-3 may be “0x09”, although other values are considered herein. One technical benefit is the new algorithm type distinguishers 1302 allow for derivation of new CIE keys 1010 (i.e., the K_{NASaead} key 1114, the K_{RRCaead} key 1115, and the K_{UPaead} key 1116) for the combined algorithms 1000.

The enhanced security mechanisms are described in further detail below. In general, the mechanisms are implemented via one or more 5G network functions (e.g., AMF 212), one or more RAN nodes (e.g., gNB 302), and a UE 106. Block diagrams of these elements are provided below.

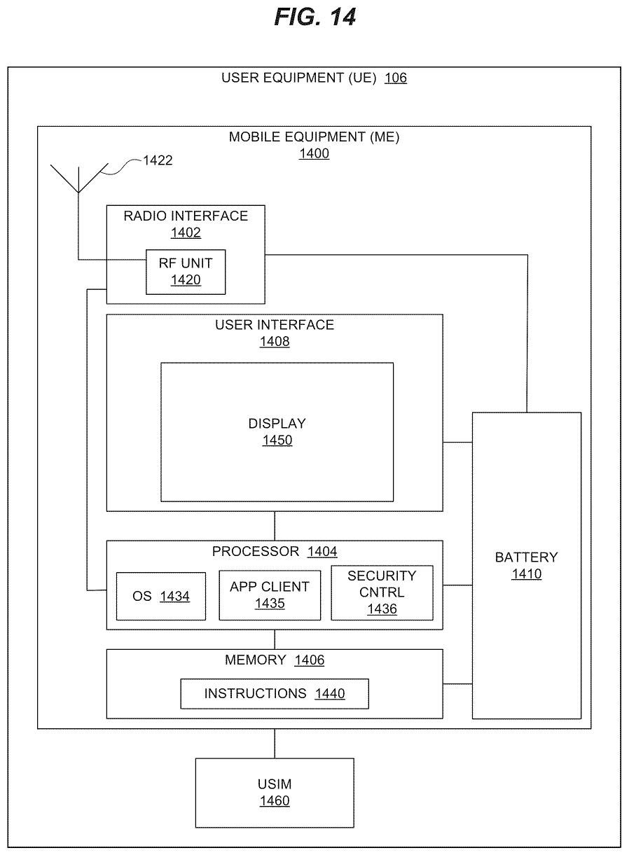

FIG. 14 is a block diagram of a UE 106 in an illustrative embodiment. From a functional standpoint, the UE 106 is composed of at least two parts: Mobile Equipment (ME) 1400 and a Universal Subscriber Identity Module (USIM) 1460. ME 1400 comprises a radio interface component 1402, one or more processors 1404, a memory 1406, and a user interface component 1408. The UE 106 may also comprise a battery 1410. Radio interface component 1402 is a hardware component or means that represents the local radio resources of the UE 106, such as a Radio Frequency (RF) unit 1420 (e.g., one or more radio transceivers) and one or more antennas 1422. Radio interface component 1402 may be configured for 5G New Radio (NR), Long Term Evolution (LTE), WiFi, Bluetooth, etc. Processor 1404 represents the internal circuitry, logic, hardware, means, etc., that provides the functions of the UE 106. Processor 1404 may be configured to execute instructions 1440 for software that are loaded into memory 1406. Processor 1404 may execute an Operating System (OS) 1434 for the UE 106 that manages hardware and software resources, and one or more application clients 1435. Processor 1404 may also execute a security controller 1436, which comprises a component or means for performing security mechanisms within the UE 106 (i.e., within the ME 1400). User interface component 1408 is a hardware component for interacting with an end user. For example, user interface component 1408 may comprise a display 1450, screen, touch screen, and/or the like (e.g., a Liquid Crystal Display (LCD), a Light Emitting Diode (LED) display, etc.). User interface component 1408 may include a keyboard or keypad, a tracking device (e.g., a trackball or trackpad), a speaker, a microphone, etc.

USIM 1460 is an integrated circuit that provides security and integrity functions for the UE 106. USIM 1460 includes or is provisioned with a subscription profile associated with a subscription of a subscriber. A subscription profile may include a variety of information, such as subscription credentials (e.g., SUPI) used to uniquely identify a subscription and to mutually authenticate the UE 106 and a network.

The UE 106 may comprise various other components not specifically illustrated in FIG. 14.

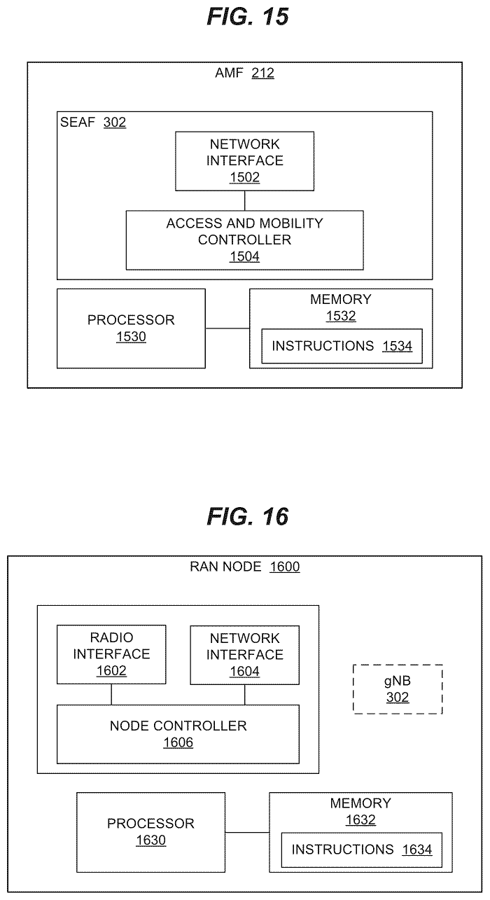

FIG. 15 is a block diagram of an AMF 212 in an illustrative embodiment. AMF 212 is a network element or network function configured provide registration management of a UE. In this embodiment, AMF 212 comprises the following subsystems: a network interface component 1502, and an access and mobility controller 1504 that operate on one or more platforms. Network interface component 1502 may comprise circuitry, logic, hardware, means, etc., configured to exchange control plane messages or signaling with other network elements and/or UEs. Network interface component 1502 may operate using a variety of protocols or reference points. Access and mobility controller 1504 may comprise circuitry, logic, hardware, means, etc., configured to support operations, procedures, or functions of an AMF.

One or more of the subsystems of AMF 212 may be implemented on a hardware platform comprised of analog and/or digital circuitry. One or more of the subsystems of AMF 212 may be implemented on one or more processors 1530 that execute instructions 1534 (i.e., computer readable code) for software that are loaded into memory 1532. One or more of the subsystems of AMF 212 may be implemented on a cloud-computing platform or another type of processing platform.

AMF 212 may comprise various other components not specifically illustrated in FIG. 15.

FIG. 16 is a block diagram of a RAN node 1600 in an illustrative embodiment. RAN node 1600 comprises a server, device, apparatus, equipment (including hardware), system, network element, means, etc., of a RAN 102 (or NG-RAN) that provides connectivity between a UE 106 and the 5GC 104. In this embodiment, RAN node 1600 comprises the following subsystems: a radio interface component 1602, a network interface component 1604, and a node controller 1606 that operate on one or more platforms. Radio interface component 1602 may comprise circuitry, logic, hardware, means, etc., configured to exchange messages or signaling with UEs via the air interface. Radio interface component 1602 may be configured for 5G NR, LTE, WiFi, Bluetooth, etc. Network interface component 1604 may comprise circuitry, logic, hardware, means, etc., configured to exchange messages or signaling with other network elements or network functions, such as of a 5GC 104. Network interface component 1604 may operate using a variety of protocols or reference points. Node controller 1606 may comprise circuitry, logic, hardware, means, etc., configured to support operations or procedures performed in a RAN node 1600 of a 5G system 100. As illustrated in FIG. 16, RAN node 1600 may represent a gNB 302, a component of a gNB 302 (e.g., a Centralized Unit (CU), a Distributed Unit (DU), and/or a Radio Unit (RU)), or another type of base station or NG base station.

One or more of the subsystems of RAN node 1600 may be implemented on a hardware platform comprised of analog and/or digital circuitry. One or more of the subsystems of RAN node 1600 may be implemented on one or more processors 1630 that execute instructions 1634 (i.e., computer readable code) for software that are loaded into memory 1632. A processor 1630 comprises an integrated hardware circuit configured to execute instructions 1634 to provide the functions of RAN node 1600. Processor 1630 may comprise a set of one or more processors or may comprise a multi-processor core, depending on the particular implementation. Memory 1632 is a non-transitory computer readable storage medium for data, instructions, applications, etc., and is accessible by processor 1630. Memory 1632 is a hardware storage device capable of storing information on a temporary basis and/or a permanent basis. Memory 1632 may comprise a random-access memory, or any other volatile or non-volatile storage device.

RAN node 1600 may comprise various other components not specifically illustrated in FIG. 16.

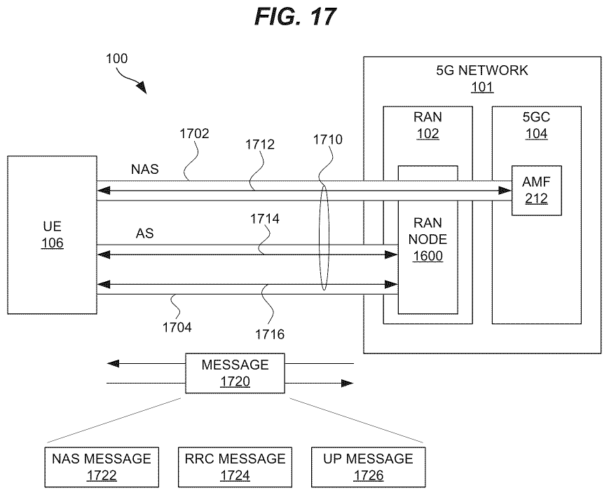

FIG. 17 illustrates the NAS functional layer 1702 and the AS functional layer 1704 of a 5G system 100 in an illustrative embodiment. The UE 106 is operatively coupled to 5G network 101. In general, communications 1710 (also referred to as 5G communications) may occur between a UE 106 and a 5G network 101, and the communications 1710 may be protected via combined algorithms 1000 as described above. The NAS functional layer 1702 is between the UE 106 and AMF 212 (or Mobility Management Entity (MME)), and therefore, NAS signaling 1712 may be exchanged between the UE 106 and AMF 212. The AS functional layer 1704 is between the UE 106 and the RAN node 1600 (e.g., gNB 302), and therefore, RRC signaling 1714 and UP traffic 1716 may be exchanged between the UE 106 and the RAN node 1600. In the communications 1710, a message 1720 may be sent from the UE 106 to the 5G network 101, or vice-versa. For example, the message 1720 may comprise a NAS message 1722 (e.g., a NAS signaling message), an RRC message 1724 (e.g., an RRC signaling message), a UP message 1726 (e.g., an IP packet), etc. A message 1720 being sent by a sender 810 may be referred to as a “sent” message, and a message 1720 received by a receiver 812 may be referred toas a “received” message. Similar language applies for signaling, user plane data, etc.

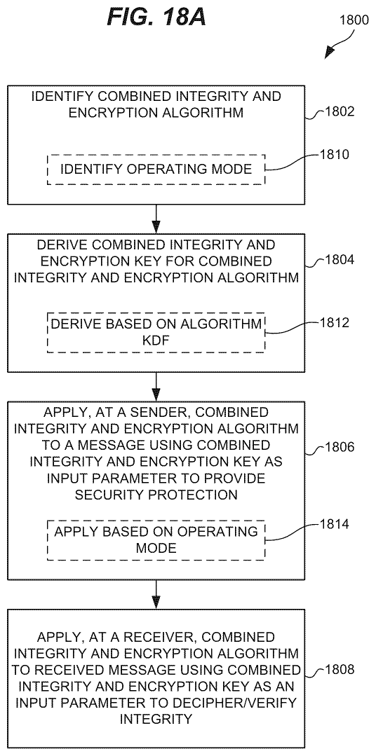

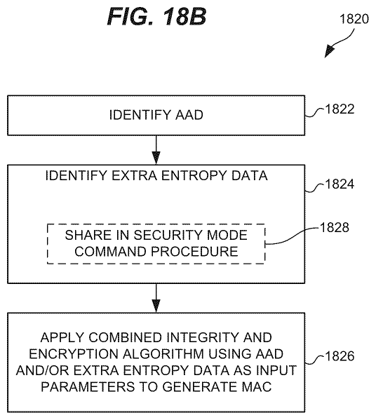

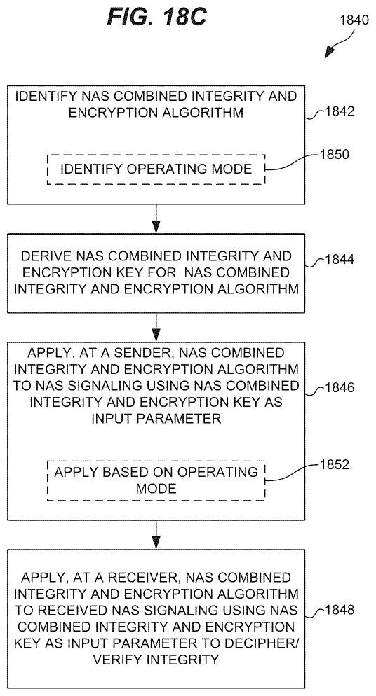

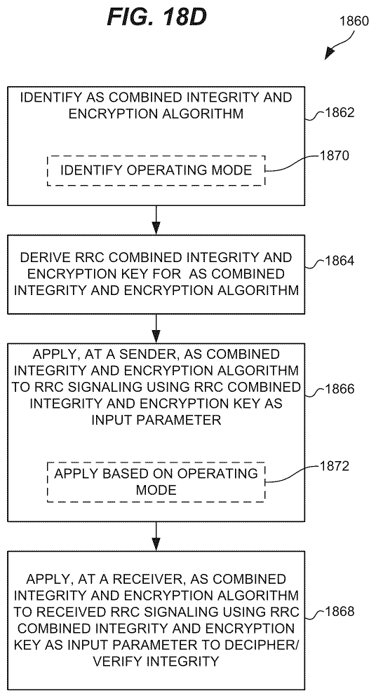

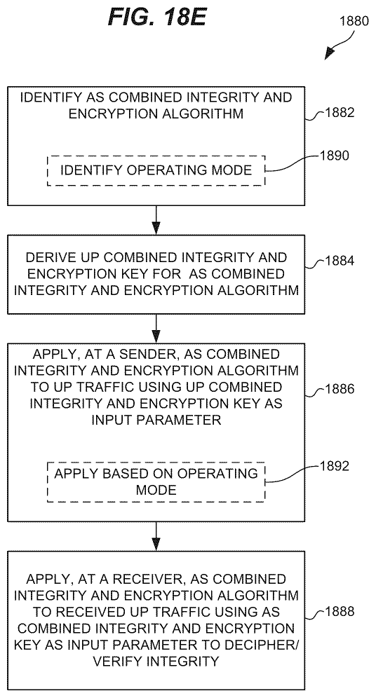

FIGS. 18A-18E are flow charts illustrating methods of performing security mechanisms in a 5G system 100 in illustrative embodiments. The steps of the methods in FIGS. 18A-18E will be described with reference to a UE 106 and a 5G network 101. The steps of the flow charts described herein are not all inclusive and may include other steps not shown, and the steps may be performed in an alternative order.

FIG. 18A is a flow chart illustrating a method 1800 of performing a security mechanism for a message 1720 or communication 1710 exchanged between a UE 106 and a 5G network 101 (e.g., AMF 212 or RAN node 1600). For the security mechanism, the UE 106 and the 5G network 101 identify a combined algorithm 1000 (step 1802) to protect the message 1720. The UE 106 and the 5G network 101 derive a CIE key 1010 for the combined algorithm 1000 (step 1804). For example, the UE 106 and the 5G network 101 may derive the CIE key 1010 as shown in FIG. 12 with an algorithm KDF 1200 (optional step 1812). The UE 106 or the 5G network 101, when operating as the sender 810 of the message 1720, applies the combined algorithm 1000 to the message 1720 (i.e., the sent message) using the CIE key 1010 as an input parameter 1002 to provide security protection to the message 1720 (step 1806). For example, the sender 810 may apply integrity protection, encryption, or both with the combined algorithm 1000. In an embodiment, combined algorithm 1000 may support multiple operating modes 1080 as described above. Thus, the UE 106 and the 5G network 101 may identify an operating mode 1080 for the combined algorithm 1000 for security protection of the message 1720 (step 1810), and the sender 810 may apply integrity protection, encryption, or both with the combined algorithm 1000 based on the operating mode 1080 selected for the message 1720 (step 1814).

The UE 106 or the 5G network 101, when operating as a receiver 812 of a message 1720, applies the combined algorithm 1000 to the message 1720 (i.e., a received message) using the CIE key 1010 as an input parameter 1002 (step 1808). The receiver 812 applies the combined algorithm 1000 to decipher the message 1720 and/or verify integrity of the message 1720, depending on the type of security protection applied by the sender 810. One technical benefit is security of messages 1720 is improved with a combined algorithm 1000 configured to perform both integrity protection and encryption.

FIG. 18B is a flow chart illustrating a method 1820 of performing integrity protection of the message 1720. As described in FIG. 10A, the input parameters 1002 to a combined algorithm 1000 include AAD 1015 and extra entropy data 1017. The AAD 1015 and extra entropy data 1017 are used in generation of a MAC 1020 or XMAC 1024 for integrity protection. Thus, the UE 106 and the 5G network 101 identify the AAD 1015 (step 1822) and/or the extra entropy data 1017 (step 1824). As described above, the AAD 1015 may be known by the UE 106 and the 5G network 101, and the extra entropy data 1017 may be shared between the 5G network 101 and the UE 106 in security mode command procedures (optional step 1828). The UE 106 and the 5G network 101 apply the combined algorithm 1000 using the AAD 1015 and/or the extra entropy data 1017 as input parameters 1002 to generate a MAC 1020 or XMAC 1024 (step 1826). One technical benefit is the AAD 1015 and/or the extra entropy data 1017 make derivation of a MAC more robust.

FIG. 18C is a flow chart illustrating a method 1840 of performing a NAS security mechanism for NAS signaling 1712 (e.g., a NAS message 1722) exchanged between a UE 106 and an AMF 212. For the NAS security mechanism, the UE 106 and the AMF 212 identify a NAS combined algorithm 1050 (step 1842) to protect the NAS signaling 1712. The UE 106 and the AMF 212 derive a NAS CIE key 1010 (e.g., the K_{NASaead} key 1114) for the NAS combined algorithm 1050 (step 1844). The UE 106 or the AMF 212, when operating as the sender 810 of the NAS signaling 1712, the NAS combined algorithm 1050 to the NAS signaling 1712 (i.e., sent NAS signaling) with using the NAS CIE key 1010 as an input parameter 1002 to provide security protection to the NAS signaling 1712 (step 1846). For example, the sender 810 may apply integrity protection, encryption, or both with the NAS combined algorithm 1050. In an embodiment, NAS combined algorithm 1050 may support multiple operating modes 1080 as described above. Thus, the UE 106 and the AMF 212 may identify an operating mode 1080 for the NAS combined algorithm 1050 for security protection of the NAS signaling 1712 (step 1850), and the sender 810 may apply integrity protection, encryption, or both with the NAS combined algorithm 1050 based on the operating mode 1080 selected for the NAS signaling 1712 (step 1852).

In general, NAS security mode command and NAS security mode complete messages are integrity protected but not encrypted. Thus, if the NAS signaling 1712 comprise a NAS security mode command or a NAS security mode complete message, then the sender 810 may apply integrity protection without encryption (e.g., integrity mode 1082). After the NAS security mode command procedure, NAS signaling 1712 may be integrity protected and encrypted. Thus, the sender 810 may apply integrity protection and encryption (e.g., integrity and encryption mode 1081) to NAS signaling 1712 that follows the NAS security mode command procedure.

The UE 106 or the AMF 212, when operating as a receiver 812 of NAS signaling 1712, applies the NAS combined algorithm 1050 to the NAS signaling 1712 (i.e., received NAS signaling) using the NAS CIE key 1010 as an input parameter 1002 (step 1848). The receiver 812 applies the NAS combined algorithm 1050 to decipher the NAS signaling 1712 and/or verify integrity of the NAS signaling 1712, depending on the type of security protection applied by the sender 810. One technical benefit is the NAS security procedures is improved with a NAS combined algorithm 1050 that is configured to perform both integrity protection and encryption.

FIG. 18D is a flow chart illustrating a method 1860 of performing an RRC security mechanism for RRC signaling 1714 exchanged between a UE 106 and a gNB 302. For the RRC security mechanism, the UE 106 and the gNB 302 identify an AS combined algorithm 1060 (step 1862) to protect the RRC signaling 1714. The UE 106 and the gNB 302 derive a RRC CIE key 1010 (e.g., the K_{RRCaead} key 1115) for the AS combined algorithm 1060 (step 1864). The UE 106 or the gNB 302, when operating as the sender 810 of the RRC signaling 1714, applies the AS combined algorithm 1060 to the RRC signaling 1714 (i.e., sent RRC signaling) using the RRC CIE key 1010 as an input parameter 1002 to provide security protection to the RRC signaling 1714 (step 1866). For example, the sender 810 may apply integrity protection, encryption, or both with the AS combined algorithm 1060. In an embodiment, AS combined algorithm 1060 may support multiple operating modes 1080 as described above. Thus, the UE 106 and the gNB 302 may identify an operating mode 1080 for the AS combined algorithm 1060 for security protection of the RRC signaling 1714 (step 1870), and the sender 810 may apply integrity protection, encryption, or both with the AS combined algorithm 1060 based on the operating mode 1080 selected for the RRC signaling 1714 (step 1872).

In general, AS security mode command and AS security mode complete messages are integrity protected but not encrypted. Thus, if the RRC signaling 1714 comprises an AS security mode command or AS security mode complete message, then the sender 810 may apply integrity protection without encryption (e.g., integrity mode 1082). After the AS security mode command procedure, RRC signaling 1714 may be integrity protected and encrypted. Thus, the sender 810 may apply integrity protection and encryption (e.g., integrity and encryption mode 1081) to RRC signaling 1714 that follows the AS security mode command procedure.

The UE 106 or the gNB 302, when operating as a receiver 812 of RRC signaling 1714, applies the AS combined algorithm 1060 to the RRC signaling 1714 (i.e., received RRC signaling) using the RRC CIE key 1010 as an input parameter 1002 (step 1868). The receiver 812 applies the AS combined algorithm 1060 to decipher the RRC signaling 1714 and/or verify integrity of the RRC signaling 1714, depending on the type of security protection applied by the sender 810. One technical benefit is the RRC security procedures are improved with an AS combined algorithm 1060 that is configured to perform both integrity protection and encryption.

FIG. 18E is a flow chart illustrating a method 1880 of performing a UP security mechanism for UP traffic 1716 exchanged between a UE 106 and a gNB 302. For the UP security mechanism, the UE 106 and the gNB 302 identify an AS combined algorithm 1060 (step 1882) to protect the UP traffic 1716. The UE 106 and the gNB 302 derive a UP CIE key 1010 (e.g., the K_{UPaead} key 1116) for the AS combined algorithm 1060 (step 1884). The UE 106 or the gNB 302, when operating as the sender 810 of the UP traffic 1716, the AS combined algorithm 1060 to the UP traffic 1716 using the UP CIE key 1010 as an input parameter 1002 to provide security protection to the UP traffic 1716 (step 1886). For example, the sender 810 may apply integrity protection, encryption, or both with the AS combined algorithm 1060. In an embodiment, AS combined algorithm 1060 may support multiple operating modes 1080 as described above. Thus, the UE 106 and the gNB 302 may identify an operating mode 1080 for the AS combined algorithm 1060 for security protection of the UP traffic 1716 (step 1890), and the sender 810 may apply integrity protection, encryption, or both with the AS combined algorithm 1060 based on the operating mode 1080 selected for the UP traffic 1716 (step 1892).

In general, integrity protection and encryption are optional for UP traffic 1716. However, if security protection is applied, then the sender 810 may apply encryption (and possibly integrity protection) to UP traffic 1716.

The UE 106 or the gNB 302, when operating as a receiver 812 of UP traffic 1716, applies the AS combined algorithm 1060 to the UP traffic 1716 (i.e., received UP traffic) using the UP CIE key 1010 as an input parameter 1002 (step 1888). The receiver 812 applies the AS combined algorithm 1060 to decipher the UP traffic 1716 and/or verify integrity of the UP traffic 1716, depending on the type of security protection applied by the sender 810. One technical benefit is the UP security procedures are improved with an AS combined algorithm 1060 that is configured to perform both integrity protection and encryption.

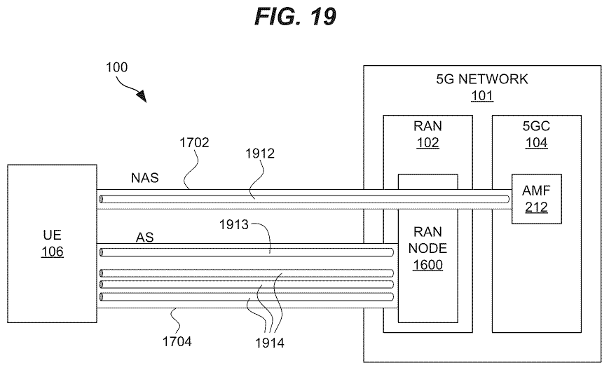

Before combined algorithms 1000 are used to protect messages 1720 or communications 1710 as described above, there are negotiations that take place between a UE 106 and the 5G network 101 to provision the use of the combined algorithms 1000. FIG. 19 illustrates the NAS functional layer 1702 and the AS functional layer 1704 in a 5G system 100 in an illustrative embodiment. In the NAS functional layer 1702, a NAS signaling connection 1912 is set up between a UE 106 and a 5G network 101 (e.g., AMF 212). In the AS functional layer 1704, an RRC signaling connection is set up between the UE 106 and a RAN node 1600 (e.g., gNB 302) via one or more SRBs 1913, and a UP connection is set up via one or more DRBs 1914.

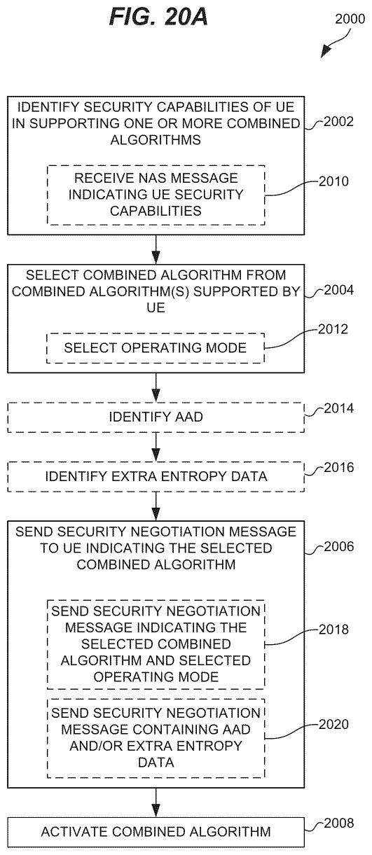

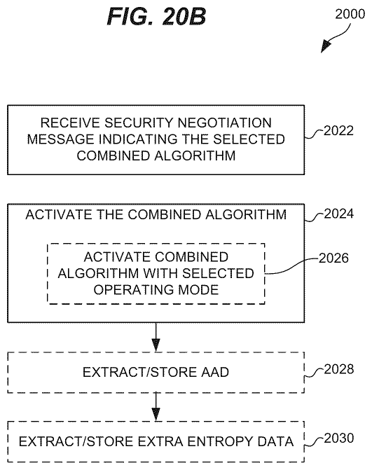

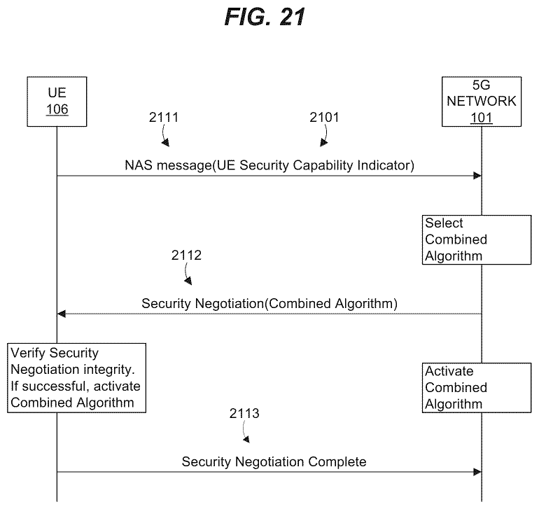

FIGS. 20A-20B are flow charts illustrating a method 2000 of negotiating security mechanisms in an illustrative embodiment. FIG. 21 is a signaling diagram illustrating negotiation of security mechanisms in an illustrative embodiment. In FIG. 20A, 5G network 101 identifies security capabilities of the UE 106 in supporting one or more combined algorithms 1000 (step 2002). In an embodiment, 5G network 101 may receive a NAS message 2111 (see FIG. 21) from the UE 106 (optional step 2010) that indicates the combined algorithm(s) 1000 supported by the UE 106, such as with a UE security capabilities indicator 2101 contained in the NAS message 2111. In FIG. 20A, 5G network 101 selects a combined algorithm 1000 from the one or more combined algorithms 1000 supported by the UE 106 (step 2004). For example, 5G network 101 may be configured via network management with a list of combined algorithms 1000 that are allowed for usage, and the combined algorithms may be ordered according to a priority decided by the operator. 5G network 101 may therefore select a combined algorithm 1000 from the list based on the capabilities of the UE 106. 5G network 101 sends a security negotiation message to the UE 106 indicating the selected combined algorithm 1000 (step 2006). As shown in FIG. 21, 5G network 101 sends a security negotiation message 2112 to the UE 106. A security negotiation message 2112 is a type of signaling message that includes one or more security parameters. For example, a security negotiation message 2112 may comprise a security mode command message. 5G network 101 may apply integrity protection (without ciphering) to the security negotiation message 2112 before sending to the UE 106. One technical benefit is the selected combined algorithm 1000 is shared with the UE 106 in the security negotiation procedure.

In an embodiment, 5G network 101 may activate the combined algorithm 1000 after sending the security negotiation message 2112 (step 2008), as shown in FIG. 21. However, 5G network 101 may activate the combined algorithm 1000 before sending the security negotiation message 2112, such as to apply integrity protection (without ciphering) to the security negotiation message 2112. In another example, 5G network 101 may activate the combined algorithm 1000 after receiving a security negotiation complete message 2113 from the UE 106.

In an embodiment, when the combined algorithm 1000 supports multiple (or a plurality of) operating modes 1080, 5G network 101 may select an operating mode 1080 from the operating modes 1080 for the combined algorithm 1000 (optional step 2012). 5G network 101 may therefore send the security negotiation message 2112 to the UE 106 that indicates the selected combined algorithm 1000 and the selected operating mode 1080 for the combined algorithm 1000 (optional step 2018). One technical benefit is the operating mode 1080 of the selected combined algorithm 1000 is shared with the UE 106 in the security negotiation procedure.

In an embodiment, the input parameters 1002 to the combined algorithm 1000 selected by the 5G network 101 may include AAD 1015 and/or extra entropy data 1017 used in generation of a MAC 1020 or XMAC 1024 for integrity protection. Thus, the 5G network 101 may identify the AAD 1015 (optional step 2014) and/or the extra entropy data 1017 (optional step 2016). 5G network 101 may therefore send the security negotiation message 2112 to the UE 106 containing the AAD 1015 and/or the extra entropy data 1017 (optional step 2020). One technical benefit is the AAD 1015 and/or the extra entropy data 1017 may be shared with the UE 106 in the security negotiation procedure.

In FIG. 20B, the UE 106 receives the security negotiation message 2112 from the 5G network 101 indicating the selected combined algorithm 1000 (step 2022). When the security negotiation message 2112 is integrity protected, the UE 106 verifies the integrity of the security negotiation message 2112. For example, the UE 106 may compute a MAC from the security negotiation message 2112, and compare the computed MAC to a MAC received in the security negotiation message 2112. The UE 106 activates the combined algorithm 1000 indicated in the security negotiation message 2112 to protect communications 1710 (step 2024). In other words, the UE 106 activates the combined algorithm 1000 selected by the 5G network 101 to protect subsequent or future communications with the 5G network 101, such as integrity protection, encryption, or both. The UE 106 may also send a security negotiation complete message 2113 to the 5G network 101 (see FIG. 21).

In an embodiment, when the UE 106 receives an operating mode 1080 in the security negotiation message 2112, the UE 106 activates the combined algorithm 1000 using the selected operating mode 1080 (optional step 2026). In other words, the UE 106 activates the combined algorithm 1000 to perform integrity protection, encryption, or both, based on the selected operating mode 1080. In an embodiment, when the UE 106 receives AAD 1015 and/or extra entropy data 1017 in the security negotiation message 2112, the UE 106 may extract the AAD 1015 (optional step 2028) and/or the extra entropy data 1017 (optional step 2030) from the security negotiation message 2112. The UE 106 stores the AAD 1015 and the extra entropy data 1017, and may use the AAD 1015 and/or the extra entropy data 1017 as input parameters 1002 to the selected combined algorithm 1000 to generate a MAC.

One technical benefit of method 2000 is that the 5G network 101 is able to share a selected combined algorithm 1000 and other information (e.g., operating mode 1080, AAD 1015, extra entropy data 1017, etc.) with the UE 106 when negotiating security parameters.

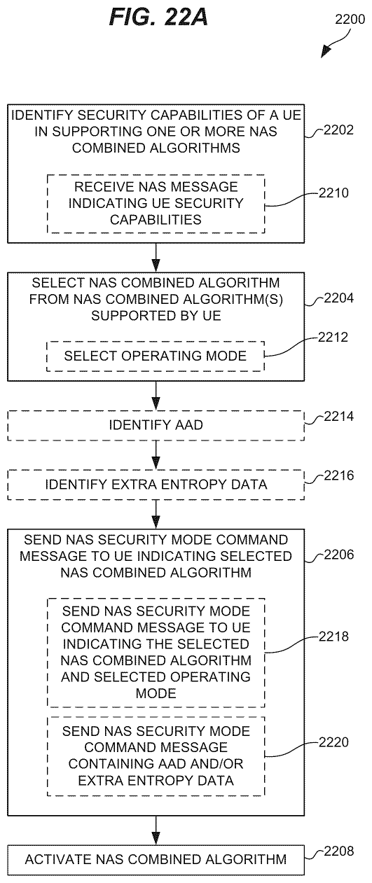

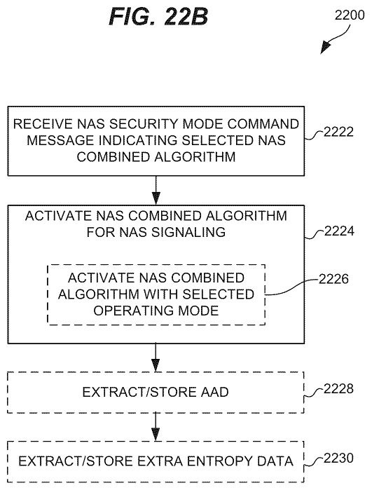

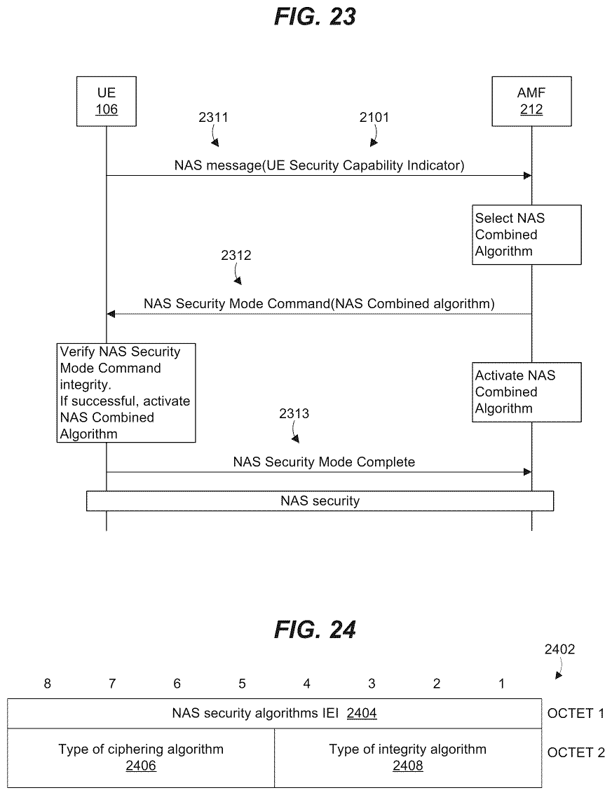

FIGS. 22A-22B are flow charts illustrating a method 2200 of negotiating NAS security mechanisms in an illustrative embodiment. FIG. 23 is a signaling diagram illustrating a NAS security procedure between a UE 106 and AMF 212 of a 5G network 101 in an illustrative embodiment. In FIG. 22A, AMF 212 of 5G network 101 identifies security capabilities of a UE 106 in supporting one or more NAS combined algorithms 1050 (step 2202). In an embodiment, AMF 212 may receive a NAS message 2311 (see FIG. 23) from the UE 106 (optional step 2210) indicating the NAS combined algorithm(s) 1050 supported by the UE 106, such as with a UE security capabilities indicator 2101 contained in the NAS message 2311. The NAS message 2311 may comprise an N1 message 411 (i.e., an initial NAS message) as shown in FIG. 4A, such as a Registration Request. AMF 212 selects a NAS combined algorithm 1050 from the one or more NAS combined algorithms 1050 supported by the UE 106 (step 2204). AMF 212 sends a NAS security mode command message to the UE 106 indicating the selected NAS combined algorithm 1050 (step 2206). As shown in FIG. 23, AMF 212 sends a NAS security mode command message 2312 to the UE 106. AMF 212 may apply integrity protection (without ciphering) to the NAS security mode command message 2312 before sending to the UE 106. One technical benefit is the selected NAS combined algorithm 1050 is shared with the UE 106 in the NAS security mode command procedure.

In an embodiment, AMF 212 may activate the NAS combined algorithm 1050 after sending the NAS security mode command message 2312 (step 2208), as shown in FIG. 23. However, AMF 212 may activate the NAS combined algorithm 1050 before sending the NAS security mode command message 2312, such as to apply integrity protection (without ciphering) to the NAS security mode command message 2312. In another example, AMF 212 may activate the NAS combined algorithm 1050 after receiving a NAS security mode complete message 2313 from the UE 106.

In an embodiment, when the NAS combined algorithm 1050 supports multiple operating modes 1080, AMF 212 may select an operating mode 1080 from the operating modes 1080 for the NAS combined algorithm 1050 (optional step 2212). AMF 212 may therefore send the NAS security mode command message 2312 to the UE 106 indicating the selected NAS combined algorithm 1050 and the selected operating mode 1080 (optional step 2218). One technical benefit is the operating mode 1080 of the selected NAS combined algorithm 1050 is shared with the UE 106 in the NAS security mode command procedure.

In an embodiment, the input parameters 1002 to a NAS combined algorithm 1050 may include AAD 1015 and/or extra entropy data 1017 used in generation of a NAS-MAC 1052 or XNAS-MAC 1054 for integrity protection. Thus, AMF 212 may identify the AAD 1015 (optional step 2214) and/or the extra entropy data 1017 (optional step 2216). AMF 212 may therefore send the NAS security mode command message 2312 to the UE 106 containing the AAD 1015 and/or the extra entropy data 1017 (optional step 2220). Examples of the AAD 1015 may comprise a 5G-TMSI 1056, a truncated 5G-S-TMSI 1057, an S-NSSAI 1058, etc. The extra entropy data 1017 may comprise a random number generated by the AMF 212. One technical benefit is the AAD 1015 and/or the extra entropy data 1017 are shared with the UE 106 in the NAS security mode command procedure.

In FIG. 22B, the UE 106 receives the NAS security mode command message 2312 from the AMF 212 indicating the selected NAS combined algorithm 1050 (step 2222). When the NAS security mode command message 2312 is integrity protected, the UE 106 verifies the integrity of the NAS security mode command message 2312. The UE 106 activates the NAS combined algorithm 1050 indicated in the NAS security mode command message 2312 to protect NAS signaling 1712 (step 2224). In other words, the UE 106 activates the NAS combined algorithm 1050 selected by the AMF 212 to protect subsequent or future NAS signaling 1712, such as integrity protection, encryption, or both. The UE 106 also sends a NAS security mode complete message 2313 to the AMF 212 (see FIG. 23).

In an embodiment, when the UE 106 receives an operating mode 1080 in the NAS security mode command message 2312, the UE 106 activates the NAS combined algorithm 1050 using the selected operating mode 1080 to protect NAS signaling 1712 (optional step 2226). In other words, the UE 106 activates the NAS combined algorithm 1050 to perform integrity protection, encryption, or both, based on the selected operating mode 1080. In an embodiment, when the UE 106 receives AAD 1015 and/or extra entropy data 1017 in the NAS security mode command message 2312, the UE 106 may extract the AAD 1015 (optional step 2228) and/or the extra entropy data 1017 (optional step 2230) from the NAS security mode command message 2312. The UE 106 stores the AAD 1015 and the extra entropy data 1017, and may use the AAD 1015 and/or the extra entropy data 1017 as input parameters 1002 to the selected NAS combined algorithm 1050 to generate a NAS-MAC 1052 or XNAS-MAC 1054.

One technical benefit of method 2200 is that the AMF 212 is able to share a selected NAS combined algorithm 1050 and other information (e.g., operating mode 1080, AAD 1015, extra entropy data 1017, etc.) with the UE 106 in the NAS security mode command procedure.

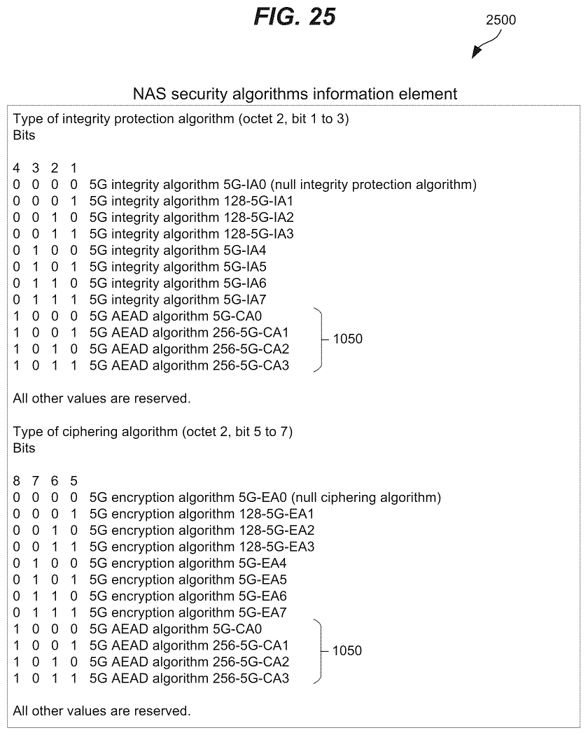

In an embodiment, the NAS security mode command procedure may be extended to indicate the selected NAS combined algorithm 1050. As indicated in section 8.2.25 of 3GPP TS 24.501, the message content of the NAS security mode command includes a “Selected NAS security algorithms” Information Element (IE) of data type “NAS security algorithms”. The Selected NAS security algorithms IE is used in a NAS security mode command to indicate the 5G algorithms to be used for ciphering and integrity protection. In embodiments described herein, the NAS security algorithms IE may be extended to include one or more NAS combined algorithms 1050. FIG. 24 is a block diagram illustrating the NAS security algorithms IE 2402, as described in section 9.11.3.34 of 3GPP TS 24.501. The NAS security algorithms IE 2402 includes a NAS security algorithms IE identifier (IEI) 2404 (in octet 1), and a type of ciphering algorithm parameter 2406 and a type of integrity algorithm parameter 2408 (in octet 2). The NAS security algorithms IE 2402 is coded based on information defined in Table 9.11.3.34.1 of 3GPP TS 24.501. FIG. 25 is a block diagram illustrating an extension to the coding 2500 for the NAS security algorithms IE 2402 in an illustrative embodiment. In this embodiment, one or more NAS combined algorithms 1050 are defined for the NAS security algorithms IE 2402. For example, the value of “1000” is defined for the “5G-CA0” NAS combined algorithm 1050, the value of “1001” is defined for the “256-5G-CA1” NAS combined algorithm 1050, the value of “1010” is defined for the “256-5G-CA2” NAS combined algorithm 1050, and the value of “1011” is defined for the “256-5G-CA3” NAS combined algorithm 1050. These values and particular NAS combined algorithms 1050 are provided as an example, and other values and algorithms are considered herein. One technical benefit is the NAS security mode command message 2312 is able to indicate a NAS combined algorithm 1050 for a NAS security context.

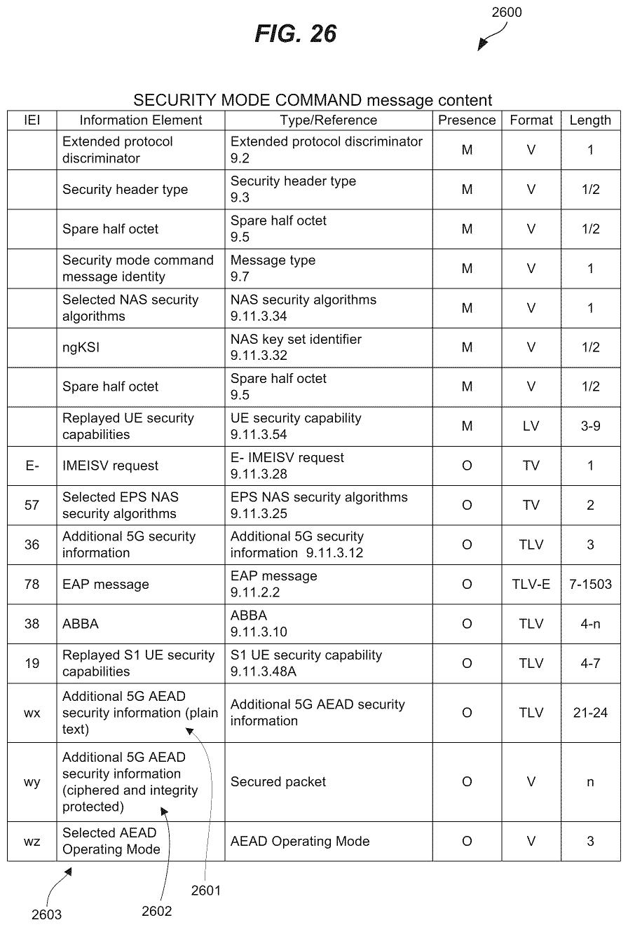

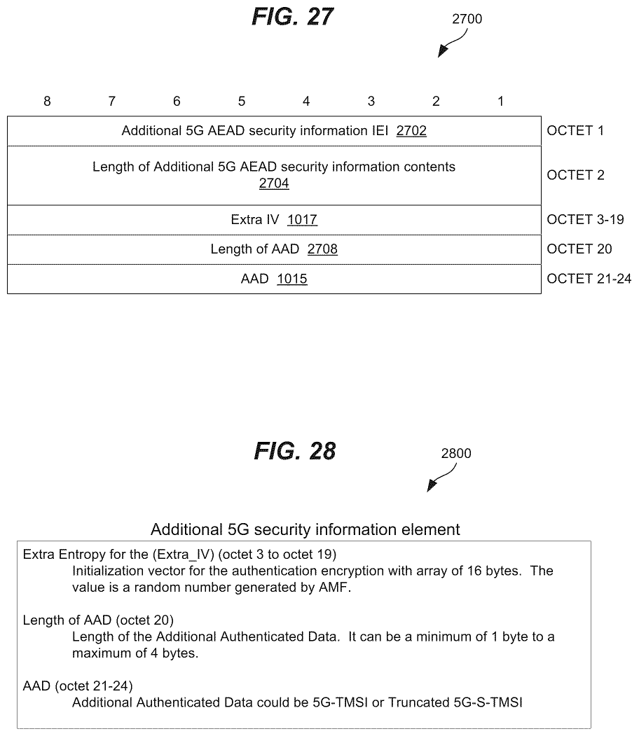

One or both of the AAD 1015 and the extra entropy data 1017 may be shared with the UE 106 during the NAS security mode command procedure as described above. Thus, the NAS security mode command message 2312 may be extended to contain the AAD 1015 and/or extra entropy data 1017. FIG. 26 is a block diagram illustrating NAS security mode command message content 2600 in an illustrative embodiment. NAS security mode command message content 2600 as in FIG. 26 represents an extension to Table 8.2.25.1.1 of 3GPP TS 24.501. In this embodiment, the NAS security mode command message content 2600 further includes one or more additional combined algorithm security information IEs 2601-2602. The purpose of the additional combined algorithm security information IEs 2601-2602 is to provide the UE 106 with the additional security parameters. One of the additional combined algorithm security information IEs 2601 labeled “Additional 5G AEAD security information (plain text)” is of type “Additional 5G AEAD security information”, although the name may vary as desired. FIG. 27 is a block diagram illustrating an additional 5G AEAD security information IE 2700 in an illustrative embodiment. The additional 5G AEAD security information IE 2700 includes an additional 5G AEAD security information IEI 2702, a length 2704 of the additional 5G AEAD security information contents, the extra entropy data 1017 (i.e., Extra IV), the length 2708 of the AAD, and the AAD 1015.

The purpose of the additional 5G AEAD security information IE 2700 is to provide the UE 106 with additional security parameters (e.g., Extra IV and AAD) during a security mode command procedure. The UE 106 uses these additional security parameters to completion of the security mode procedure. The additional 5G AEAD security information IE 2700 is coded as shown in FIG. 28, which illustrates a coding 2800 for the additional 5G AEAD security information IE 2700 in an illustrative embodiment. One technical benefit is the NAS security mode command message 2312 is able to contain additional security information for a NAS security context.

As described above, the NAS combined algorithm 1050 selected by the AMF 212 may support multiple operating modes 1080, and AMF 212 may select an operating mode 1080 from the operating modes 1080 for the selected NAS combined algorithm 1050 (see optional step 2212 of FIG. 22A). In an embodiment, the NAS security mode command message 2312 may be extended to contain an operating mode indicator. As shown in FIG. 26, the NAS security mode command message content 2600 may further include an operating mode indicator IE 2603. The purpose of the operating mode indicator IE 2603 is to provide the UE 106 with an operating mode 1080 for a NAS combined algorithm 1050 selected by the AMF 212. The operating mode indicator IE 2603 may have a data type as desired. The operating mode indicator IE 2603 may contain an IE type identifier and 4-bit value field to indicate the operating mode 1080. One technical benefit is the NAS security mode command message 2312 is able to indicate a selected operation mode 1080 for a NAS combined algorithm 1050.

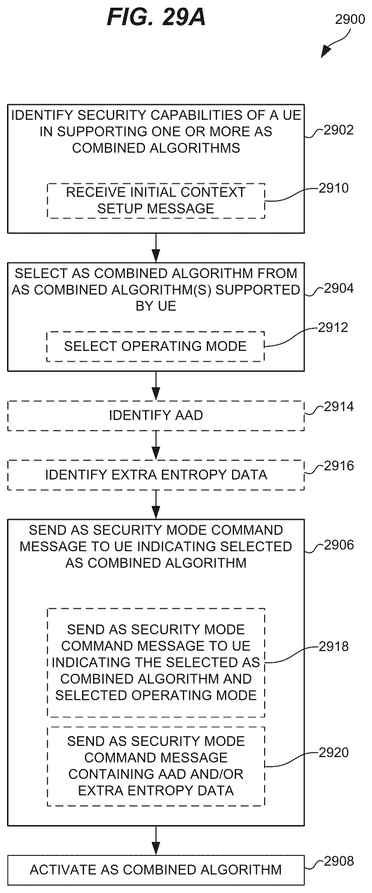

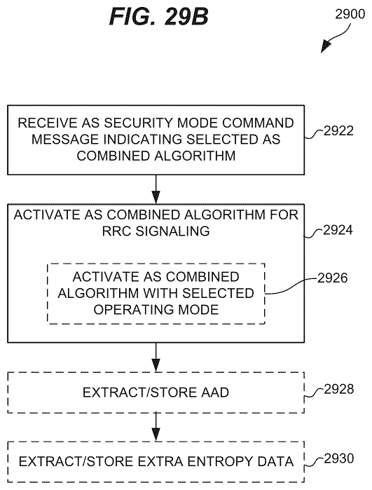

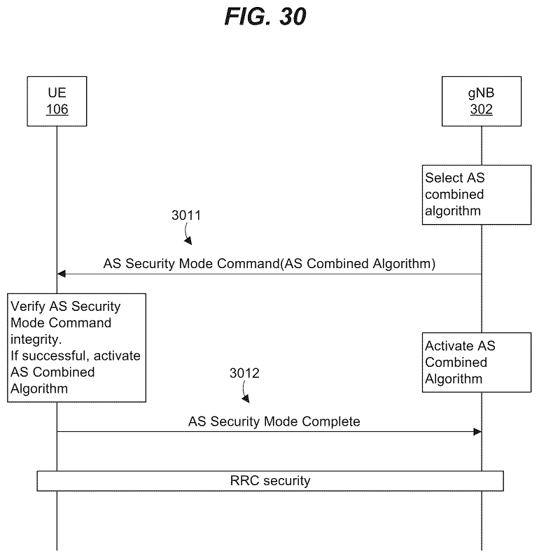

FIGS. 29A-29B are flow charts illustrating a method 2900 of performing an RRC security mechanism in an illustrative embodiment, to set up RRC security between a UE 106 and a gNB 302 of a 5G network 101. FIG. 30 is a signaling diagram illustrating an RRC security procedure between a UE 106 and a gNB 302 in an illustrative embodiment. In FIG. 29A, the gNB 302 of 5G network 101 identifies security capabilities of the UE 106 in supporting one or more AS combined algorithms 1060 (step 2902). In an embodiment, the gNB 302 may receive an NGAP Initial Context Setup message 513 (see FIG. 5) from the AMF 212 (optional step 2910) indicating the AS combined algorithm(s) 1060 supported by the UE 106. The gNB 302 selects an AS combined algorithm 1060 from the one or more AS combined algorithms 1060 supported by the UE 106 (step 2904). The gNB 302 sends an AS security mode command message 3011 (see FIG. 30) to the UE 106 indicating the selected AS combined algorithm 1060 (step 2906). As shown in FIG. 30, AMF 212 sends an AS security mode command message 3011 to the UE 106. The gNB 302 may apply integrity protection (without ciphering) to the AS security mode command message 3011 before sending to the UE 106. One technical benefit is the selected AS combined algorithm 1060 is shared with the UE 106 in the AS security mode command procedure.

In an embodiment, the gNB 302 may activate the AS combined algorithm 1060 after sending the AS security mode command message 3011 (step 2908), as shown in FIG. 30. However, the gNB 302 may activate the AS combined algorithm 1060 before sending the AS security mode command message 3011, such as to apply integrity protection (without ciphering) to the AS security mode command message 3011. In another example, the gNB 302 may activate the AS combined algorithm 1060 after receiving an AS security mode complete message 3012 from the UE 106.

In an embodiment, when the AS combined algorithm 1060 supports multiple operating modes 1080, the gNB 302 may select an operating mode 1080 from the operating modes 1080 for the AS combined algorithm 1060 (optional step 2912). The gNB 302 may therefore send the AS security mode command message 3011 to the UE 106 indicating the selected AS combined algorithm 1060 and the selected operating mode 1080 (optional step 2918). One technical benefit is the operating mode 1080 of the selected AS combined algorithm 1060 is shared with the UE 106 in the AS security mode command procedure.

In an embodiment, the input parameters 1002 to an AS combined algorithm 1060 may include AAD 1015 and/or extra entropy data 1017 used in generation of a MAC-I 1062 or XMAC-I 1064 for integrity protection. Thus, the gNB 302 may identify the AAD 1015 (optional step 2914) and/or the extra entropy data 1017 (optional step 2916). The gNB 302 may therefore send the AS security mode command message 3011 to the UE 106 containing the AAD 1015 and/or the extra entropy data 1017 (optional step 2920). Examples of the AAD 1015 may comprise an RNTI 1066, a PCI 1067, a combination of the RNTI and PCI, etc. The extra entropy data 1017 may comprise a random number generated by the gNB 302. One technical benefit is the AAD 1015 and/or extra entropy data 1017 are shared with the UE 106 in the AS security mode command procedure.

In FIG. 29B, the UE 106 receives the AS security mode command message 3011 from the gNB 302 indicating the selected AS combined algorithm 1060 (step 2922). When the AS security mode command message 3011 is integrity protected, the UE 106 verifies the integrity of the AS security mode command message 3011. The UE 106 activates the AS combined algorithm 1060 indicated in the AS security mode command message 3011 to protect RRC signaling 1714 (step 2924). In other words, the UE 106 activates the AS combined algorithm 1060 selected by the gNB 302 to protect subsequent or future RRC signaling 1714, such as integrity protection, encryption, or both. The UE 106 also sends an AS security mode complete message 3012 to the gNB 302 (see FIG. 30).

In an embodiment, when the UE 106 receives an operating mode 1080 in the AS security mode command message 3011, the UE 106 activates the AS combined algorithm 1060 using the selected operating mode 1080 to protect RRC signaling 1714 (optional step 2926). In other words, the UE 106 activates the AS combined algorithm 1060 to perform integrity protection, encryption, or both, based on the selected operating mode 1080. In an embodiment, when the UE 106 receives AAD 1015 and/or extra entropy data 1017 in the AS security mode command message 3011, the UE 106 may extract the AAD 1015 (optional step 2928) and/or the extra entropy data 1017 (optional step 2930) from the AS security mode command message 3011. The UE 106 stores the AAD 1015 and the extra entropy data 1017, and may use the AAD 1015 and the extra entropy data 1017 as input parameters 1002 to the selected AS combined algorithm 1060 to generate a MAC-I 1062 or XMAC-I 1064.

One technical benefit of method 2900 is that the gNB 302 is able to share a selected AS combined algorithm 1060 and other information (e.g., operating mode 1080, AAD 1015, extra entropy data 1017, etc.) with the UE 106 in the AS security mode command procedure.

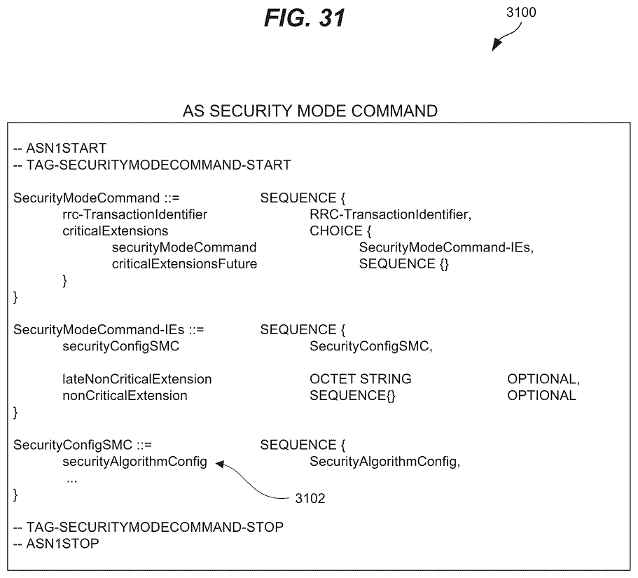

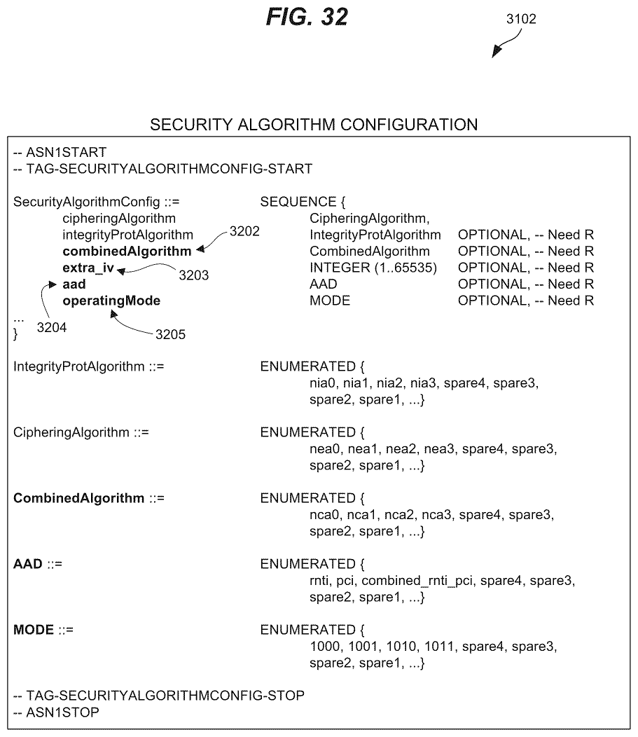

In an embodiment, the AS security mode command procedure may be extended to indicate at least one of the selected AS combined algorithm 1060, the AAD 1015, the extra entropy data 1017, and the operating mode 1080. Section 6.2 of 3GPP TS 38.331 (v 17.5.0) specifies the message structure and message definitions of an RRC message, which is incorporated by reference as if fully included herein. FIG. 31 illustrates the message content 3100 of an AS security mode command message 3011, as indicated in section 6.2.2 of 3GPP TS 38.331. Particularly, the AS security mode command message 3011 includes a security algorithm configuration IE 3102, which is used to configure the AS integrity protection algorithm and the AS ciphering algorithm for radio bearers (i.e., SRBs and DRBs). Described herein is an extension to the security algorithm configuration IE 3102 as defined in section 6.3.2 of 3GPP TS 38.331. FIG. 32 illustrates a security algorithm configuration IE 3102 in an illustrative embodiment. In an embodiment, one or more of the following new fields are defined for the security algorithm configuration IE 3102: a combined algorithm field 3202 (i.e., “combinedAlgorithm”), an extra entropy data field 3203 (i.e., “extra_iv”), an AAD field 3204 (i.e., “aad”), and an operating mode field 3205 (i.e., “operatingMode”). The combined algorithm field 3202 indicates the AS combined algorithm 1060 to use for SRBs and/or DRBs. The extra entropy data field 3203 indicates the extra entropy data 1017 (e.g., random number generated by the gNB 302). The AAD field 3204 indicates the AAD 1015, which may comprise an RNTI 1066, a PCI 1067, a combined RNTI and PCI, etc. The operating mode field 3205 indicates the selected operating mode 1080 for the AS combined algorithm 1060.

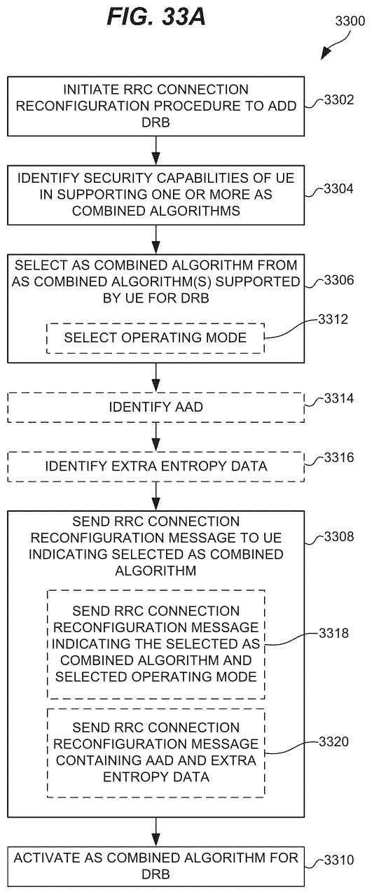

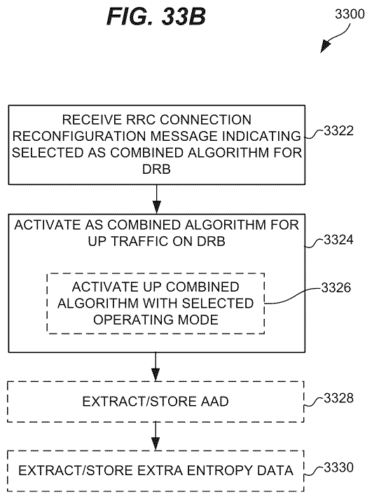

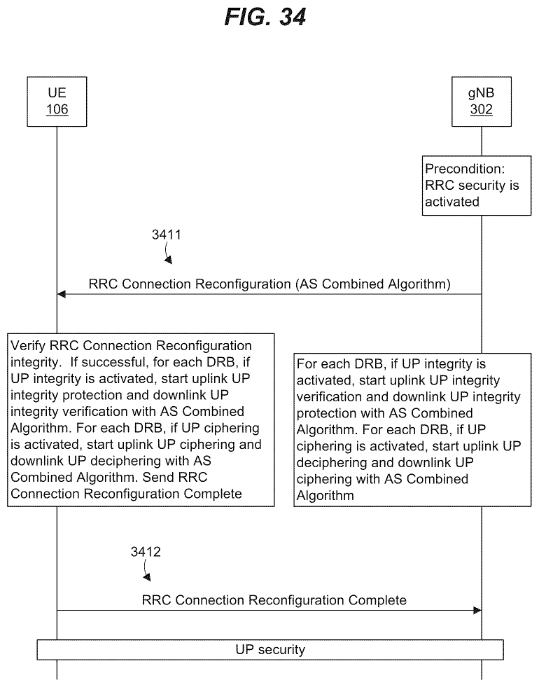

FIGS. 33A-33B are flow charts illustrating a method 3300 of performing a UP security procedure in an illustrative embodiment, to set up UP security between a UE 106 and a gNB 302 of a 5G network 101. FIG. 34 is a signaling diagram illustrating a UP security procedure between a UE 106 and a gNB 302 in an illustrative embodiment. UP security is activated as part of a DRB addition procedure, where an RRC connection reconfiguration procedure is used to add one or more DRBs for a PDU session. The RRC connection reconfiguration procedure is described in 3GPP TS 36.331 (v. 17.5.0), which is incorporated by reference as if fully included herein. The purpose of the RRC connection reconfiguration procedure, at least in part, is to modify an RRC connection (e.g., to establish, modify, or release radio bearers). In FIG. 33A, the gNB 302 initiates the RRC connection reconfiguration procedure (step 3302). A precondition is that RRC security has been activated as part of the AS security mode command procedure. The gNB 302 of 5G network 101 identifies security capabilities of UE 106 in supporting one or more AS combined algorithms 1060 (step 3304), if not performed already in a prior security procedure. The gNB 302 selects AS combined algorithm 1060 from the one or more AS combined algorithms 1060 supported by the UE 106 for a DRB 1914 (step 3306). The gNB 302 sends the RRC connection reconfiguration message to the UE 106 indicating the selected AS combined algorithm 1060 (step 3308). As shown in FIG. 34, the gNB 302 sends an RRC connection reconfiguration message 3411 to the UE 106. The gNB 302 may apply integrity protection to the RRC connection reconfiguration message 3411 before sending to the UE 106. One technical benefit is the selected AS combined algorithm 1060 for a DRB 1914 is shared with the UE 106 in the RRC connection reconfiguration procedure.

In an embodiment, the gNB 302 may activate the AS combined algorithm 1060 for the DRB 1914 after sending the RRC connection reconfiguration message 3411 (step 3310), as shown in FIG. 34. However, the gNB 302 may activate the AS combined algorithm 1060 before sending the RRC connection reconfiguration message 3411, such as to apply integrity protection (without ciphering) to the RRC connection reconfiguration message 3411. In another example, the gNB 302 may activate the AS combined algorithm 1060 after receiving an RRC connection reconfiguration complete message 3412 from the UE 106.

In an embodiment, when the AS combined algorithm 1060 supports multiple operating modes 1080, the gNB 302 may select an operating mode 1080 from the operating modes 1080 for the AS combined algorithm 1060 (optional step 3312). The gNB 302 may therefore send the RRC connection reconfiguration message 3411 to the UE 106 indicating the selected AS combined algorithm 1060 and the selected operating mode 1080 (optional step 3318). One technical benefit is the operating mode 1080 of the selected AS combined algorithm 1060 is shared with the UE 106 in the RRC connection reconfiguration procedure.

In an embodiment, the input parameters 1002 to the AS combined algorithm 1060 may include AAD 1015 and/or extra entropy data 1017 used in generation of a MAC-I 1062 or XMAC-I 1064 for integrity protection. Thus, the gNB 302 may identify the AAD 1015 (optional step 3314) and/or the extra entropy data 1017 (optional step 3316). The gNB 302 may therefore send the RRC connection reconfiguration message 3411 to the UE 106 containing the AAD 1015 and/or the extra entropy data 1017 (optional step 3320). Examples of the AAD 1015 may comprise an RNTI 1066, a PCI 1067, a combination of the RNTI and PCI, etc. The extra entropy data 1017 may comprise a random number generated by the gNB 302. One technical benefit is the AAD 1015 and/or extra entropy data 1017 are shared with the UE 106 in the RRC connection reconfiguration procedure.

In FIG. 33B, the UE 106 receives the RRC connection reconfiguration message 3411 from the gNB 302 indicating the selected AS combined algorithm 1060 (step 3322). When the RRC connection reconfiguration message 3411 is integrity protected by the gNB 302, the UE 106 verifies the integrity of the RRC connection reconfiguration message 3411. The UE 106 activates the AS combined algorithm 1060 indicated in the RRC connection reconfiguration message 3411 to protect UP traffic 1716 on the DRB 1914 (step 3324). In other words, the UE 106 activates the AS combined algorithm 1060 selected by the gNB 302 to protect subsequent or future UP traffic 1716 on the DRB 1914, such as integrity protection, encryption, or both. The UE 106 also sends an RRC connection reconfiguration complete message 3412 to the gNB 302 (see FIG. 34).

In an embodiment, when the UE 106 receives an operating mode 1080 in the RRC connection reconfiguration message 3411, the UE 106 activates the AS combined algorithm 1060 using the selected operating mode 1080 to protect UP traffic 1716 (optional step 3326). In other words, the UE 106 activates the AS combined algorithm 1060 to perform integrity protection, encryption, or both, based on the selected operating mode 1080.

In an embodiment, when the UE 106 receives the AAD 1015 and/or extra entropy data 1017 in the RRC connection reconfiguration message 3411, the UE 106 may extract the AAD 1015 (optional step 3328) and extra entropy data 1017 (optional step 3330) from the RRC connection reconfiguration message 3411. The UE 106 stores the AAD 1015 and/or the extra entropy data 1017, and may use the AAD 1015 and the extra entropy data 1017 as input parameters 1002 to the AS combined algorithm 1060 to generate a MAC-I 1062 or XMAC-I 1064.

Method 3300 may be used to activate UP security for multiple DRBs 1914. One technical benefit is that the gNB 302 is able to share a selected AS combined algorithm 1060 and other information (e.g., operating mode 1080, AAD 1015, extra entropy data 1017, etc.) with the UE 106 in the RRC connection reconfiguration procedure for individual DRBs 1914. However, it is understood that UP security may be configured in the AS security mode command procedure as discussed above.

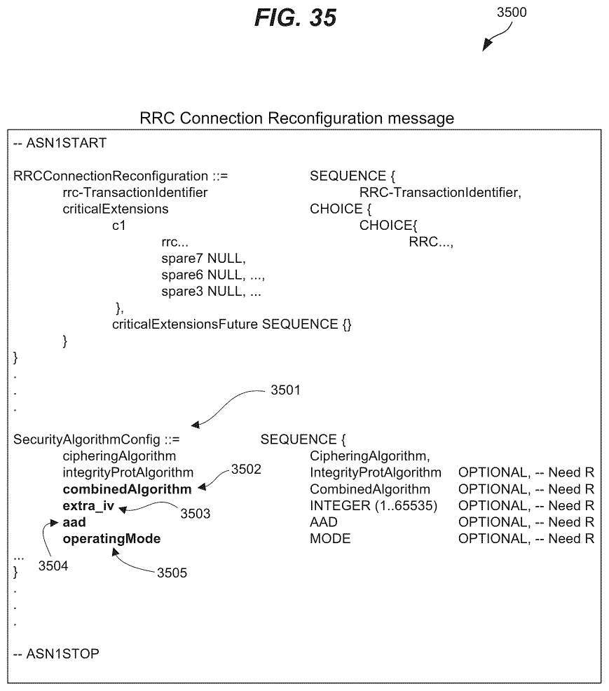

In an embodiment, the RRC connection reconfiguration procedure may be extended to indicate or contain at least one of the selected AS combined algorithm 1060, the AAD 1015, the extra entropy data 1017, and the operating mode 1080. Section 6.2 of 3GPP TS 36.331 (v 17.5.0) specifies the message structure and message definitions of an RRC message, which is incorporated by reference as if fully included herein. FIG. 35 illustrates the message content 3500 of an RRC connection reconfiguration message 3411 in an illustrative embodiment. Particularly, the RRC connection reconfiguration message 3411 includes a security algorithm configuration field 3501 used to configure the UP integrity protection algorithm and the UP ciphering algorithm for radio bearers (i.e., DRBs). Described herein is an extension to the security algorithm configuration field 3501 of the RRC connection reconfiguration message 3411 as defined in 3GPP TS 36.331. In an embodiment, one or more of the following new fields are defined: a combined algorithm field 3502 (i.e., “combinedAlgorithm”), an extra entropy data field 3503 (i.e., “extra_iv”), an additional authenticated data field 3504 (i.e., “aad”), and an operating mode field 3505 (i.e., “operatingMode”). The combined algorithm field 3502 indicates the AS combined algorithm 1060 to use for a DRB (an AS combined algorithm 1060 may be selected per DRB 1914). The extra entropy data field 3503 indicates the extra entropy data 1017 (e.g., random number generated by the gNB 302). The additional authenticated data field 3504 indicates the AAD 1015, which may comprise an RNTI 1066, a PCI 1067, a combined RNTI and PCI, etc. The operating mode field 3505 indicates the selected operating mode 1080 for an AS combined algorithm 1060.

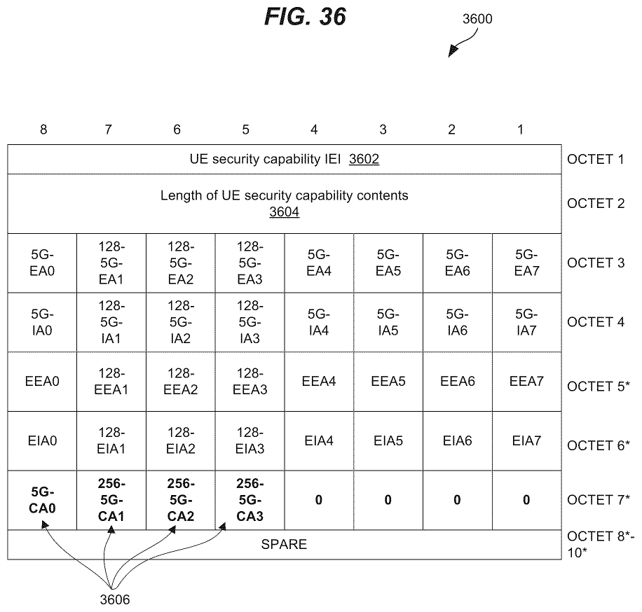

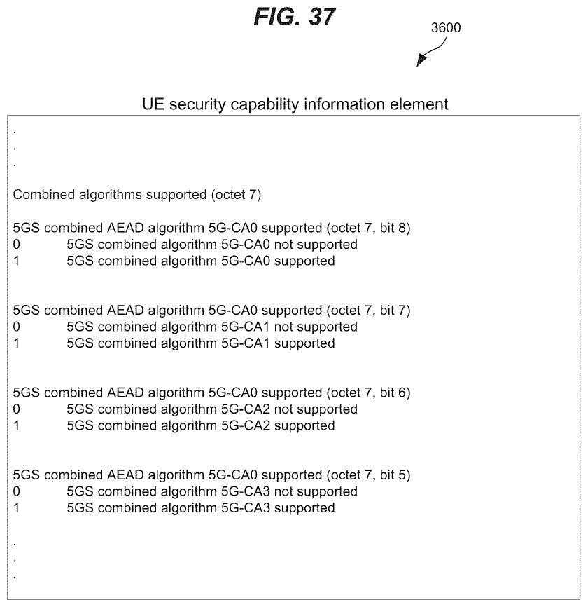

In an embodiment, a UE 106 may report UE security capabilities to the 5G network 101 in a NAS message. As shown in FIG. 21, for example, a UE 106 may include a UE security capabilities indicator 2101 in a NAS message 2111 to the 5G network 101. One example of a NAS message 2111 is a NAS registration request, such as described in section 8.2.6 of 3GPP TS 24.501. The message content of the NAS registration request includes a “UE security capability” Information Element (IE) of data type “UE security capability”. The UE security capability IE may therefore represent the UE security capabilities indicator 2101. In embodiments described herein, the UE security capability IE may be extended to include one or more combined algorithms 1000. FIG. 36 is a block diagram illustrating the UE security capability IE 3600, as described in section 9.11.3.54 of 3GPP TS 24.501. The UE security capability IE 3600 includes a UE security capability IEI 3602 (in octet 1), a length 3604 of the UE security capability contents (in octet 2), and a plurality of security algorithm parameters indicating conventional encryption (e.g., 5G-EA0) and integrity protection (e.g., 5G-IA0) algorithms supported by the UE 106 (in octets 3-6). In this embodiment, UE security capability IE 3600 is extended to further include one or more security algorithm parameters 3606 indicating combined algorithms 1000 (e.g., 5G-CA0) supported by the UE 106 (in octet 7*). The UE security capability IE 3600 is coded based on information defined in Table 9.11.3.54.1 of 3GPP TS 24.501. FIG. 37 is a block diagram illustrating an extension to the coding for UE security capability IE 3600 in an illustrative embodiment. FIG. 37 illustrates the extension to the coding for octet “7” of the UE security capability IE 3600, as an example. One technical benefit is the UE 106 is able to report capabilities for combined algorithms 1000 with a NAS message.

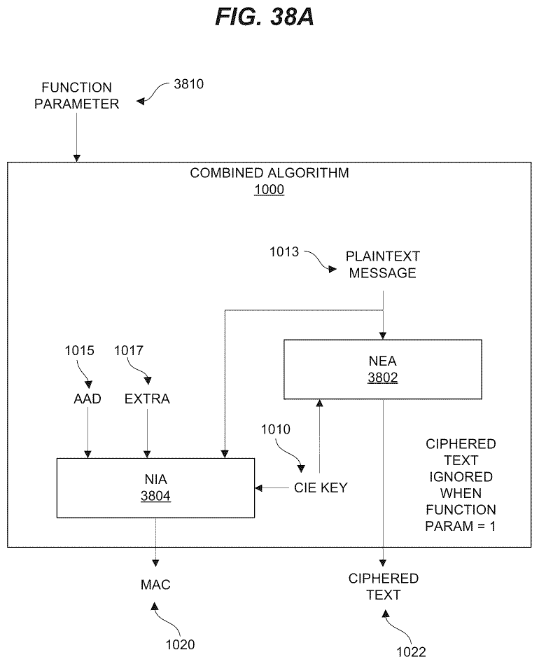

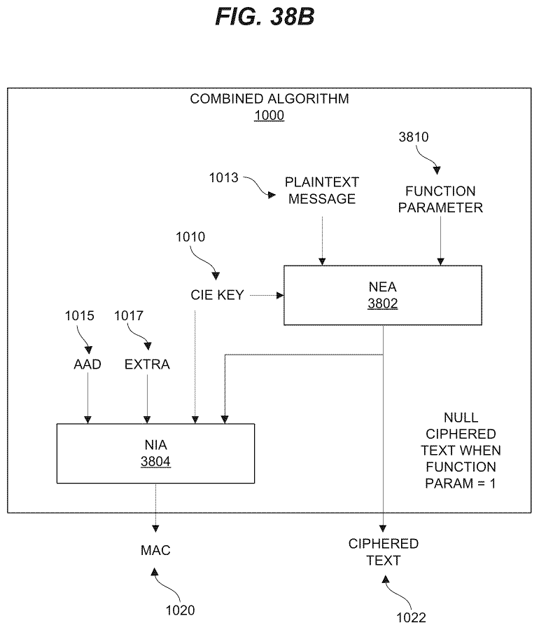

As described above for FIG. 10D, a combined algorithm 1000 may support multiple operating modes 1080, such as integrity mode 1082. FIGS. 38A-38B illustrate two integrity modes 1082 in an illustrative embodiment. FIG. 38A is a block diagram illustrating an encoding for an ignore encryption and integrity mode 1085 in an illustrative embodiment. For this encoding, combined algorithm 1000 includes an encryption algorithm 3802 (NEA) and an integrity algorithm 3804 (NIA), which use a single CIE key 1010. The integrity algorithm 3804 generates a MAC based on input parameters 1002 that include the plaintext message 1013, the AAD 1015, and the extra entropy data 1017. When a function parameter 3810 of the combined algorithm 1000 is set to a particular value (e.g., “1”), the ciphered text 1022 output from encryption algorithm 3802 is ignored, and is not sent in a communication (i.e., the plaintext message is sent). Thus, the communication has integrity protection, but is not encrypted.

FIG. 38B is a block diagram illustrating an encoding for a NULL encryption and integrity mode 1086 in an illustrative embodiment. For this encoding, combined algorithm 1000 again includes an encryption algorithm 3802 (NEA) and an integrity algorithm 3804 (NIA), which use a single CIE key 1010. The integrity algorithm 3804 generates a MAC based on input parameters 1002 that include the ciphered text 1022, the AAD 1015, and the extra entropy data 1017. When a function parameter 3810 of the combined algorithm 1000 is set to a particular value (e.g., “1”), the encryption algorithm 3802 applies NULL encryption and the output of the encryption algorithm 3802 is not ciphered. Thus, the communication has integrity protection, but is not encrypted.

Based on the different operating modes 1080 for a combined algorithm 1000, the 5G network 101 may activate a combined algorithm 1000 in integrity mode 1082 to apply integrity protection to an initial security negotiation message 2112, such as a NAS security mode command message 2312. After a security procedure has been established (e.g., a NAS security context), the 5G network 101 may activate the combined algorithm 1000 in integrity and encryption mode 1081 to apply integrity protection and encryption to subsequent messages. For example, in FIG. 38A, the function parameter may be set to “0” so that ciphered text 1022 from the encryption algorithm 3802 is not ignored. In FIG. 38B, for example, the function parameter may be set to “0” so that the encryption algorithm 3802 outputs ciphered text 1022.

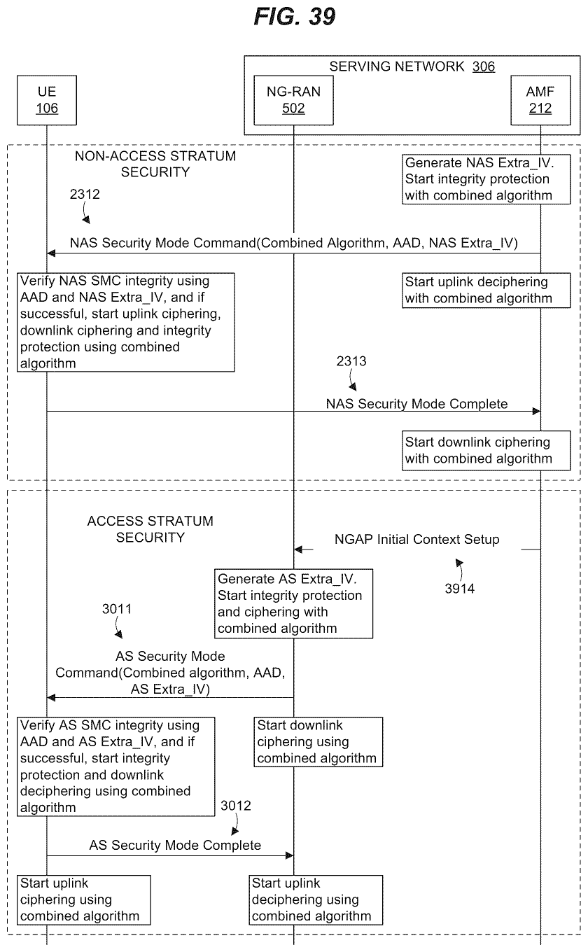

In an embodiment, a combined algorithm 1000 may be used to protect security mode command messages. FIG. 39 is a signaling diagram illustrating NAS and AS security procedures in an illustrative embodiment. For NAS security, a NAS security mode command procedure is performed to establish a NAS security context between the UE 106 and the AMF 212. To establish the NAS security context, AMF 212 selects a NAS combined algorithm 1050, derives the NAS CIE key 1010 (e.g., the K_{NASaead} key 1114) for the selected NAS combined algorithm 1050, and identifies/generates the AAD 1015 and extra entropy data 1017 (e.g., NAS Extra_IV). AMF 212 initiates the NAS security mode command procedure by sending a NAS security mode command message 2312 to the UE 106, with the NAS security mode command message 2312 indicating the selected NAS combined algorithm 1050 and containing the AAD 1015 and extra entropy data 1017 used in generation of the NAS-MAC. AMF 212 activates NAS integrity protection before sending the NAS security mode command message 2312, so the NAS security mode command message 2312 is integrity protected (but not ciphered) with the NAS combined algorithm 1050. AMF 212 activates NAS uplink de-ciphering after sending the NAS security mode command message 2312.

On receipt of the NAS security mode command message 2312, the UE 106 verifies the integrity of the NAS security mode command message 2312 using the indicated NAS combined algorithm 1050, the AAD 1015, and extra entropy data 1017 provided in NAS security mode command message 2312, and the NAS CIE key 1010 derived by the UE 106. If verification is successful, the UE 106 begins NAS integrity protection and ciphering/deciphering with the NAS combined algorithm 1050. UE 106 sends a NAS security mode complete message 2313 to AMF 212 that is ciphered and integrity protected with the NAS combined algorithm 1050. AMF 212 de-ciphers and checks the integrity protection of the received NAS security mode complete message 2313, and activates NAS downlink ciphering after receiving the NAS security mode complete message 2313.

An AS security mode command procedure is performed to establish an AS security context between the UE 106 and the NG-RAN 502. When the AS security context is to be established in the gNB 302, AMF 212 sends an NGAP Initial Context Setup message 3914 to the NG-RAN 502 (e.g., gNB 302). The gNB 302 selects an AS combined algorithm 1060, derives an RRC CIE key 1010 (e.g., the K_{RRCaead} key 115) for the selected AS combined algorithm 1060, and identifies/generates the AAD 1015 and extra entropy data 1017 (e.g., AS Extra_IV). The gNB 302 starts integrity protection and encryption for RRC signaling. Thus, the gNB 302 sends an integrity protected and encrypted AS security mode command message 3011 to the UE 106 indicating the selected AS combined algorithm 1060 and containing the AAD 1015 and extra entropy data 1017 used in generation of the MAC-I. RRC downlink ciphering at the gNB 302 starts after sending the AS security mode command message 3011.

On receipt of the AS security mode command message 3011, the UE 106 verifies the integrity of the AS security mode command message 3011 and deciphers the AS security mode command message 3011 using the indicated AS combined algorithm 1060, the AAD 1015, and extra entropy data 1017 provided in AS security mode command message 3011, and the RRC CIE key 1010 derived by the UE 106. If verification is successful, the UE 106 activates RRC integrity protection and ciphering/deciphering with the AS combined algorithm 1060. The UE 106 sends an AS security mode complete message 3012 to the gNB 302 that is ciphered and integrity protected with the AS combined algorithm 1060. AMF 212 de-ciphers and checks the integrity of the received AS security mode complete message 3012, and activates RRC downlink ciphering after receiving the AS security mode complete message 3012.

In an embodiment, the 5G network 101 and the UE 106 may support legacy encryption and integrity algorithms, as well as new combined algorithms 1000. The 5G network 101 may activate a legacy integrity algorithm 800 to apply integrity protection to an initial security negotiation message 2112, such as a NAS security mode command message 2312 or AS security mode command message 3011, without encryption. After the initial security negotiation message 2112, the 5G network 101 and the UE 106 may activate a combined algorithm 1000 to apply integrity protection and encryption to subsequent messages.

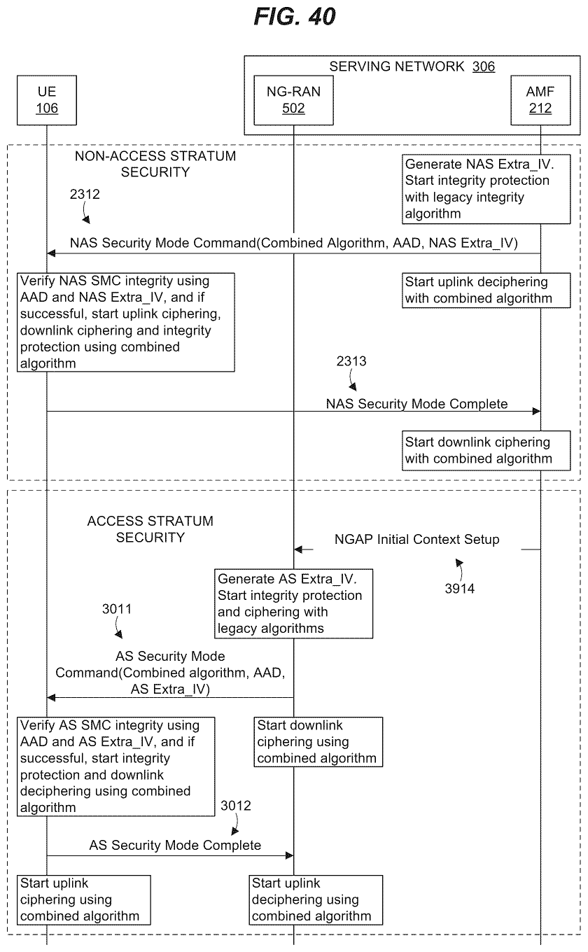

FIG. 40 is a signaling diagram illustrating NAS and AS security procedures in an illustrative embodiment. For the NAS security context, AMF 212 uses a legacy integrity algorithm 800 (e.g., AES-256/SNOW-256/ZUC-256) to apply integrity protection to the NAS security mode command message 2312. The NAS security mode command message 2312 includes the newly selected NAS combined algorithm 1050, extra entropy data 1017 (NAS Extra_IV), and AAD 1015. The UE 106 uses the legacy integrity algorithm 800 to verify the integrity of the NAS security mode command message 2312. The UE 106 receives the indication of the selected NAS combined algorithm 1050, extra entropy data 1017, and AAD 1015, and activates the NAS combined algorithm 1050 to protect subsequent NAS signaling, such as the NAS security mode complete message 2313.

Similarly for the AS security context, the gNB 302 uses a legacy integrity algorithm 800 (e.g., AES-256/SNOW-256/ZUC-256) to apply integrity protection to the AS security mode command message 3011. The AS security mode command message 3011 includes the newly selected AS combined algorithm 1060, extra entropy data 1017 (AS Extra_IV), and AAD 1015. The UE 106 uses the legacy integrity algorithm 800 to verify the integrity of the AS security mode command message 3011. The UE 106 receives the indication of the selected AS combined algorithm 1060, extra entropy data 1017, and AAD 1015, and activates the AS combined algorithm 1060 to protect subsequent RRC signaling, such as the AS security mode complete message 3012.

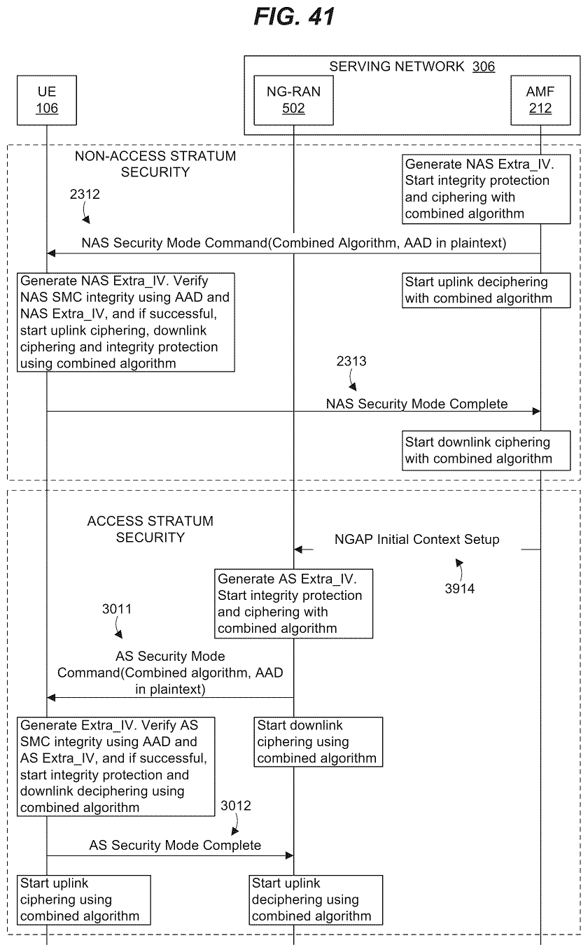

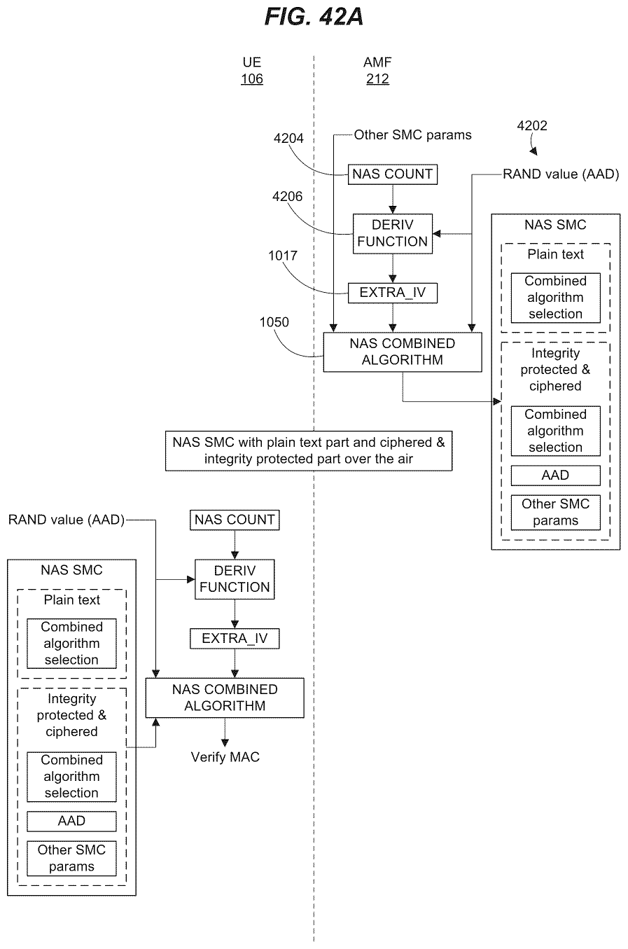

In embodiments described above, the 5G network 101 provides the extra entropy data 1017 to the UE 106, such as in a NAS security mode command message 2312 or AS security mode command message 3011. In an embodiment, the UE 106 may derive the extra entropy data 1017 instead of receiving the extra entropy data 1017 from the 5G network 101. FIG. 41 is a signaling diagram illustrating NAS and AS security procedures in an illustrative embodiment. In this embodiment, AMF 212 does not send the extra entropy data 1017 to the UE 106 in the NAS security mode command message 2312. Instead, the UE 106 derives the extra entropy data 1017 for the NAS security context. Similarly, the gNB 302 does not send the extra entropy data 1017 to the UE 106 in the AS security mode command message 3011. Instead, the UE 106 derives the extra entropy data 1017 for the AS security context.

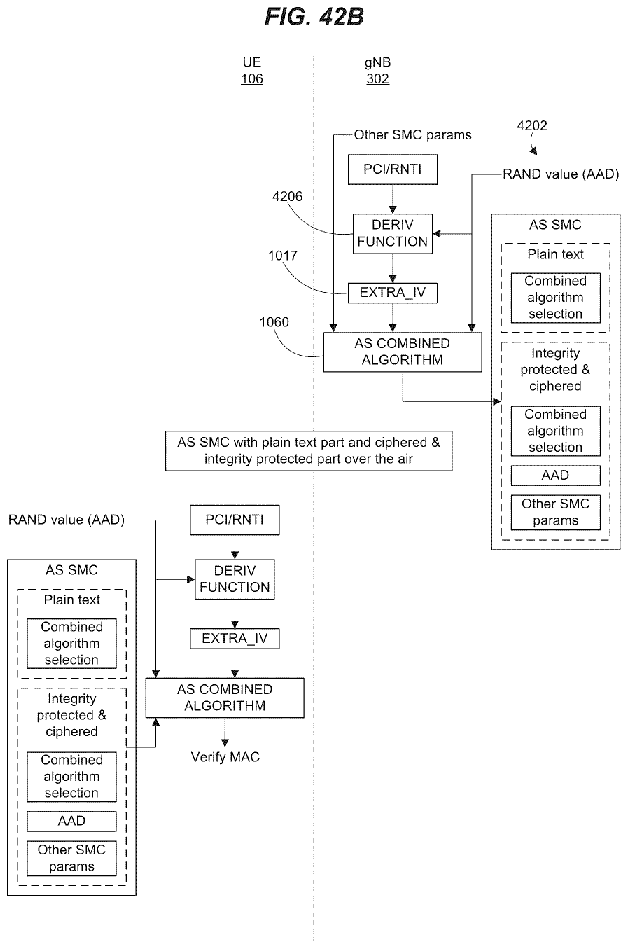

FIGS. 42A-42B illustrate derivation of extra entropy data 1017 in illustrative embodiments. In FIG. 42A, AMF 212 derives the extra entropy data 1017 for a NAS security context using the RAND 4202 (i.e., re-used from primary authentication) and the NAS COUNT 4204 as input parameters into a derivation function 4206. AMF 212 sends the NAS security mode command message 2312 to the UE 106, with the indication of the selected NAS combined algorithm 1050 in plaintext and other parameters encrypted. The UE 106 derives the extra entropy data 1017 in the same manner as AMF 212 using the RAND 4202 and the NAS COUNT 4204 as input parameters into the derivation function 4206. The UE 106 is able to verify the integrity of the NAS security mode command message 2312, and decipher the parameters.

In FIG. 42B, the gNB 302 derives the extra entropy data 1017 for an AS security context using the RAND 4202 and the RNTI 1066, PCI 1067, a combination of the RNTI and PCI, etc., as input parameters into a derivation function 4206. The gNB 302 sends the AS security mode command message 3011 to the UE 106, with the indication of the AS combined algorithm 1060 in plaintext and other parameters encrypted. The UE 106 derives the extra entropy data 1017 in the same manner as the gNB 302 using the RAND 4202 and the RNTI 1066, PCI 1067, a combination of the RNTI and PCI, etc., as input parameters into the derivation function 4206. The UE 106 is able to verify the integrity of the AS security mode command message 3011, and decipher the parameters.

One technical benefit of deriving the extra entropy data 1017 at the sender 810 and the receiver 812 is that extra entropy data 1017 does not need to be shared in security mode command procedures.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

What is claimed is:

1. An apparatus of a network (101), the apparatus comprising:
an access and mobility management function (212) operatively coupled to user equipment (106) to negotiate security mechanisms (300);
the access and mobility management function comprising:
at least one processor, and at least one memory including computer program code, wherein the at least one memory and the computer program code are configured, with the at least one processor, to cause the access and mobility management function at least to perform:
identifying security capabilities of the user equipment in supporting one or more non-access stratum combined integrity and encryption algorithms;
selecting a non-access stratum combined integrity and encryption algorithm from the one or more non-access stratum combined integrity and encryption algorithms to protect non-access stratum signaling (1712); and
sending a non-access stratum security mode command message (2312) to the user equipment indicating the non-access stratum combined integrity and encryption algorithm.

2. The apparatus of claim 1, wherein:
the non-access stratum combined integrity and encryption algorithm supports multiple operating modes (1080);
the selecting comprises selecting an operating mode (1080) from the multiple operating modes for the non-access stratum combined integrity and encryption algorithm; and
the sending comprises sending the non-access stratum security mode command message to the user equipment indicating the non-access stratum combined integrity and encryption algorithm and the operating mode for the non-access stratum combined integrity and encryption algorithm.

3. The apparatus of claim 2, wherein:
the multiple operating modes at least comprise:
an integrity and encryption mode (1081);
an integrity mode (1082);
an encryption mode (1083); and
NULL encryption and NULL integrity mode (1084).

4. The apparatus of claim 3, wherein:
the integrity mode comprises at least one of:
an ignore encryption and integrity mode (1085), where the non-access stratum combined integrity and encryption algorithm is configured to apply integrity protection and encryption to the non-access stratum signaling using a non-access stratum combined integrity and encryption key (1114), but ciphered data is ignored; and
NULL encryption and integrity mode (1086), where the non-access stratum combined integrity and encryption algorithm is configured to apply integrity protection and NULL encryption to the non-access stratum signaling using the non-access stratum combined integrity and encryption key.

5. The apparatus of claim 2, wherein:
the non-access stratum security mode command message is extended to indicate the non-access stratum combined integrity and encryption algorithm and the operating mode selected from the multiple operating modes for the non-access stratum combined integrity and encryption algorithm.

6. The apparatus of claim 1, wherein:
the non-access stratum combined integrity and encryption algorithm uses at least one of additional authenticated data (1015) and extra entropy data (1017) as input parameters (1002) to generate a non-access stratum message authentication code (1052).

7. The apparatus of claim 6, wherein:
the additional authentication data comprises one of:
a 5G temporary mobile subscriber identity, TMSI, (1056) of the user equipment;
a truncated 5G-S-TMSI (1057); or
network slice selection assistance information (1058).

8. The apparatus of claim 6, wherein:
the extra entropy data comprises a random number generated by the access and mobility management function.

9. The apparatus of claim 6, wherein:
the at least one memory and the computer program code are configured, with the at least one processor, to cause the access and mobility management function to perform:
identifying the additional authenticated data (1015); and
identifying the extra entropy data (1017);
wherein the sending comprises sending the non-access stratum security mode command message to the user equipment containing at least one of the additional authenticated data and the extra entropy data.

10. An apparatus of a network (101), the apparatus comprising:
a radio access network node (1600) operatively coupled to user equipment (106) to negotiate security mechanisms (300);
the radio access network node comprising:
at least one processor, and at least one memory including computer program code, wherein the at least one memory and the computer program code are configured, with the at least one processor, to cause the radio access network node at least to perform:
identifying security capabilities of the user equipment in supporting one or more access stratum combined integrity and encryption algorithms (1060);
selecting an access stratum combined integrity and encryption algorithm from the one or more access stratum combined integrity and encryption algorithms to protect radio resource control signaling; and
sending an access stratum security mode command message (3011) to the user equipment indicating the access stratum combined integrity and encryption algorithm.

11. The apparatus of claim 10, wherein:
the access stratum combined integrity and encryption algorithm supports multiple operating modes (1080);
the selecting comprises selecting an operating mode (1080) from the multiple operating modes for the access stratum combined integrity and encryption algorithm selected to protect the radio resource control signaling; and
the sending comprises sending the access stratum security mode command message to the user equipment indicating the access stratum combined integrity and encryption algorithm and the operating mode for the access stratum combined integrity and encryption algorithm.

12. The apparatus of claim 11, wherein:
the multiple operating modes at least comprise:
an integrity and encryption mode (1081);
an integrity mode (1082);
an encryption mode (1083); and
NULL encryption and NULL integrity mode (1084).

13. The apparatus of claim 12, wherein:
the integrity mode comprises at least one of:
an ignore encryption and integrity mode (1085), where the access stratum combined integrity and encryption algorithm is configured to apply integrity protection and encryption, but ciphered data is ignored; and
NULL encryption and integrity mode (1086), where the access stratum combined integrity and encryption algorithm is configured to apply integrity protection and NULL encryption.

14. The apparatus of claim 11, wherein:
a security algorithm configuration information element (3102) of the access stratum security mode command message is extended to indicate the access stratum combined integrity and encryption algorithm and the operating mode selected from the multiple operating modes for the access stratum combined integrity and encryption algorithm.

15. The apparatus of claim 10, wherein:
the access stratum combined integrity and encryption algorithm uses at least one of additional authenticated data (1015) and extra entropy data (1017) as input parameters (1002) to generate a message authentication code (1062).

16. The apparatus of claim 15, wherein:
the additional authentication data comprises at least one of:
a radio network temporary identifier (1066); and
a physical cell identifier (1067).

17. The apparatus of claim 15, wherein:
the extra entropy data comprises a random number generated by the radio access network node.

18. An apparatus operatively coupled to a network (101), the apparatus comprising:
user equipment (106) comprising:
at least one processor, and at least one memory including computer program code, wherein the at least one memory and the computer program code are configured, with the at least one processor, to cause the user equipment at least to perform:
receiving a non-access stratum security mode command message (2312) from an access and mobility management function (212), wherein the non-access stratum security mode command message indicates a non-access stratum combined integrity and encryption algorithm (1050) selected by the access and mobility management function; and
activating the non-access stratum combined integrity and encryption algorithm indicated in the non-access stratum security mode command message to protect non-access stratum signaling (1712).

19. The apparatus of claim 18, wherein the at least one memory and the computer program code are configured, with the at least one processor, to cause the user equipment to perform:
receiving an access stratum security mode command message from a radio access network node (1600), wherein the access stratum security mode command message indicates an access stratum combined integrity and encryption algorithm (1060) selected by the radio access network node; and
activating the access stratum combined integrity and encryption algorithm indicated in the access stratum security mode command message to protect radio resource control signaling (1714).

20. The apparatus of claim 19, wherein the at least one memory and the computer program code are configured, with the at least one processor, to cause the user equipment to perform:
receiving a radio resource control connection reconfiguration message (3411) from the radio access network node, wherein the radio resource control connection reconfiguration message indicates an access stratum combined integrity and encryption algorithm selected by the radio access network node for a radio bearer (1914); and
activating the access stratum combined integrity and encryption algorithm to protect user plane traffic (1716) over the radio bearer.
